(19) United States
(12) Patent Application Publication
(10) Pub. No.: US 2026/0304431 A1
(43) Pub. Date: Oct. 1, 2026

(54) DEVICES AND METHODS OF COMMUNICATION

(71) Applicant: NEC Corporation, Tokyo (JP)

(72) Inventors: Peng GUAN, Beijing (CN); Yukai GAO, Beijing (CN); Gang WANG, Beijing (CN)

(73) Assignee: NEC Corporation, Tokyo (JP)

(21) Appl. No.: 19/477,154

(22) PCT Filed: Apr. 25, 2023
(86) PCT No.: PCT/CN2023/090601

§ 371 Date: Oct. 21, 2025

(51) Int. Cl. H04W 72/21; H04B 7/06; H04L 1/00; H04L 5/00; H04W 72/1268; H04W 72/231

(52) U.S. Cl. CPC H04W 72/21; H04B 7/0626; H04L 1/0003; H04L 5/0051; H04W 72/1268; H04W 72/231

(57) ABSTRACT

Embodiments of the present disclosure relate to devices and methods of communication. At least one SRS resource set is determined from multiple SRS resource sets based on information of an UL transmission associated with the multiple SRS resource sets, the information comprising that the UL transmission is in at least one of a first mode or a second mode. UCI is transmitted on the UL transmission in association with the at least one SRS resource set. In this way, UCI may be transmitted or multiplexed on the UL transmission with the most reliable resource, and a probability of successful UCI transmission may be improved.

### TECHNICAL FIELD

Example embodiments of the present disclosure generally relate to the field of telecommunication and in particular, to methods, devices, and computer readable media of communication for an uplink (UL) transmission.

### BACKGROUND

Currently, it has been proposed to support simultaneous transmission across multiple panels (STxMP). Further, it has been proposed to support user equipment (UE) with 8 transmitting (Tx) antennas and a physical uplink shared channel (PUSCH) transmission with 2 codewords. However, solutions of UL transmission for STxMP or 8Tx UE are still incomplete and need to be further developed.

### SUMMARY

In general, example embodiments of the present disclosure provide methods, devices and computer storage media of communication for an UL transmission.

In a first aspect, there is provided a terminal device. The terminal device comprises a processor configured to cause the terminal device to: determine at least one sounding reference signal (SRS) resource set from multiple SRS resource sets based on information of an uplink transmission associated with the multiple SRS resource sets, the information comprising that the uplink transmission is in at least one of a first mode or a second mode; and transmit, to a network device, uplink control information (UCI) on the uplink transmission in association with the at least one SRS resource set.

In a second aspect, there is provided a terminal device. The terminal device comprises a processor configured to cause the terminal device to: receive, from a network device, a configuration indicating modulation and coding scheme (MCS) indexes of codewords of an uplink transmission; in accordance with a determination that the MCS indexes have different values, determine a first codeword from the codewords based on values of the MCS indexes of the codewords and a threshold value; and transmit, based on the first codeword, UCI or a phase tracking reference signal (PTRS) to the network device.

In a third aspect, there is provided a network device. The network device comprises a processor configured to cause the network device to: determine at least one SRS resource set from multiple SRS resource sets based on information of an uplink transmission associated with the multiple SRS resource sets, the information comprising that the uplink transmission is in at least one of a first mode or a second mode; and receive, from a terminal device, UCI on the uplink transmission in association with the at least one SRS resource set.

In a fourth aspect, there is provided a network device. The network device comprises a processor configured to cause the network device to: transmit, to a terminal device, a configuration indicating MCS indexes of codewords of an uplink transmission; in accordance with a determination that the MCS indexes have different values, determine a first codeword from the codewords based on values of the MCS indexes of the codewords and a threshold value; and receive, based on the first codeword, UCI or a PTRS from the terminal device.

In a fifth aspect, there is provided a method of communication. The method comprises: determining, at a terminal device, at least one SRS resource set from multiple SRS resource sets based on information of an uplink transmission associated with the multiple SRS resource sets, the information comprising that the uplink transmission is in at least one of a first mode or a second mode; and transmitting, to a network device, UCI on the uplink transmission in association with the at least one SRS resource set.

In a sixth aspect, there is provided a method of communication. The method comprises: receiving, at a terminal device and from a network device, a configuration indicating MCS indexes of codewords of an uplink transmission; in accordance with a determination that the MCS indexes have different values, determining a first codeword from the codewords based on values of the MCS indexes of the codewords and a threshold value; and transmitting, based on the first codeword, UCI or a PTRS to the network device.

In a seventh aspect, there is provided a method of communication. The method comprises: determining, at a network device, at least one SRS resource set from multiple SRS resource sets based on information of an uplink transmission associated with the multiple SRS resource sets, the information comprising that the uplink transmission is in at least one of a first mode or a second mode; and receiving, from a terminal device, UCI on the uplink transmission in association with the at least one SRS resource set.

In an eighth aspect, there is provided a method of communication. The method comprises: transmitting, at a network device and to a terminal device, a configuration indicating MCS indexes of codewords of an uplink transmission; in accordance with a determination that the MCS indexes have different values, determining a first codeword from the codewords based on values of the MCS indexes of the codewords and a threshold value; and receiving, based on the first codeword, UCI or a PTRS from the terminal device.

In a ninth aspect, there is provided a computer readable medium having instructions stored thereon. The instructions, when executed on at least one processor, cause the at least one processor to perform the method according to any of the fifth to eighth aspects of the present disclosure.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which embodiments of the present disclosure can be implemented;

FIG. 1B illustrates example communication network in which embodiments of the present disclosure can be implemented;

FIG. 1C illustrates still another example communication network in which embodiments of the present disclosure can be implemented;

FIG. 2 illustrates a schematic diagram illustrating a process of communication according to some example embodiments of the present disclosure;

FIG. 3A illustrates a schematic diagram illustrating an example UCI transmission based on a transmission scheme according to some embodiments of the present disclosure;

FIG. 3B illustrates a schematic diagram illustrating another example UCI transmission based on a transmission scheme according to some embodiments of the present disclosure;

FIG. 4A illustrates a schematic diagram illustrating an example UCI transmission based on a transmission scheme and a repetition configuration according to some embodiments of the present disclosure;

FIG. 4B illustrates a schematic diagram illustrating another example UCI transmission based on a transmission scheme and a repetition configuration according to some embodiments of the present disclosure;

FIG. 4C illustrates a schematic diagram illustrating another example UCI transmission based on a transmission scheme and a repetition configuration according to some embodiments of the present disclosure;

FIG. 4D illustrates a schematic diagram illustrating another example UCI transmission based on a transmission scheme and a repetition configuration according to some embodiments of the present disclosure;

FIG. 4E illustrates a schematic diagram illustrating another example UCI transmission based on a transmission scheme and a repetition configuration according to some embodiments of the present disclosure;

FIG. 4F illustrates a schematic diagram illustrating another example UCI transmission based on a transmission scheme and a repetition configuration according to some embodiments of the present disclosure;

FIG. 5 illustrates a schematic diagram illustrating another process of communication according to some example embodiments of the present disclosure;

FIG. 6 illustrates a flowchart of an example method performed by a terminal device in accordance with some embodiments of the present disclosure;

FIG. 7 illustrates a flowchart of another example method performed by a terminal device in accordance with some embodiments of the present disclosure;

FIG. 8 illustrates a flowchart of an example method performed by a network device in accordance with some embodiments of the present disclosure;

FIG. 9 illustrates a flowchart of another example method performed by a network device in accordance with some embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The network device may have the function of network energy saving, Self-Organizing Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as ‘at least in part based on.” The term “one embodiment” and “an embodiment’ are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

In the present disclosure, some terms may refer to same or similar physical meaning and may be used interchangeably. Some exemplary examples are listed as below.
The terms “port(s) used for a uplink transmission”, “port(s) used for a PUSCH transmission”, “port(s) with non-zero PUSCH transmission power” and “port(s) with non-zero uplink transmission power” can be used interchangeably;
The terms “panel(s) used for a uplink transmission”, “panel(s) used for a PUSCH transmission”, “panel(s) with non-zero PUSCH transmission power” and “panel(s) with non-zero uplink transmission power” can be used interchangeably;
The terms “transmission capability information”, “UE capability information”, “capability-related information”, “capability value set”, “panel information” and “panel-related information” can be used interchangeably;
The terms “precoder”, “precoding”, “precoding matrix”, “beam”, “spatial relation information”, “spatial relation info”, “precoding information”, “precoding information and number of layers”, “precoding matrix indicator (PMI)”, “precoding matrix indicator”, “transmission precoding matrix indication”, “precoding matrix indication”, “transmission configuration indicator (TCI) state”, “transmission configuration indicator”, “quasi co-location (QCL)”, “quasi-co-location”, “QCL parameter”, “QCL assumption”, “QCL relationship” and “spatial relation” can be used interchangeably;
The terms “single TRP”, “single TCI state”, “single TCI”, “S-TCI”, “single control resource set (CORESET)”, “single CORESET pool”, “S-TRP” and “S-TCI state” can be used interchangeably;
The terms “multiple TRPs”, “multiple TCI states”, “multiple CORESETs” and “multiple control resource set pools”, “multi-TRP”, “multi-TCI state”, “multi-TCI”, “multi-CORESET” and “multi-control resource set pool”, “MTRP” and “M-TCI”, “M-TPR” can be used interchangeably;
The terms “resource(s)”, “resource(s) in a resource set”, “resource set” can be used interchangeably; and
The terms “group”, “subset”, “set” can be used interchangeably.
Further, one panel discussed herein refers to one or more antenna elements deployed at a certain area of a terminal device. A panel discussed herein can refer to downlink panel, uplink panel, panel type, panel status, capability value set, reference signal (RS) resource, RS resource set, antenna port, antenna port group, beam, beam group. In this regard, the terms (and their equivalent expressions) “panel”, “panel type”, “set of antenna port(s)”, “antenna element(s)”, “antenna array(s)” can be used interchangeably. In some embodiments, “panel” or “UE panel” in may be replaced or represented by “RS source” or “RS resource set” or “RS port(s)”. For example, one panel or one UE panel corresponds to one RS resource or one RS resource set, multiple panels correspond to multiple RS resources or multiple RS resource sets with each panel corresponds to each RS resource or RS resource set respectively.
In addition, panel information discussed herein can refer to UE panel index/identification (ID), downlink panel ID, uplink panel ID, panel type indication, panel status indication, capability value set index, RS resource ID, RS resource set ID, antenna port ID, antenna port group ID, beam ID, beam group ID. The term “per panel” may be interchangeably used with “per capability value index”, “per capability value set index”, “per RF Chain”, “per Tx RF Chain”, “per branch”, “per Tx branch”, etc.
In some embodiments, “RS” discussed in this disclosure may be replaced or represented by at least one of “SRS”, “DMRS”, “PTRS”, “CSI-RS”, etc.
As used herein, the term “TRP” refers to an antenna array (with one or more antenna elements) available to the network device located at a specific geographical location. Although some embodiments of the present disclosure are described with reference to a scenario of multi-TRPs (or a scenario of single TRP) for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below. In some embodiments, a TRP is associated with one or more RS resources or RS resource sets. In some embodiments, “TRP” discussed in this disclosure may be replaced or represented by “RS resource” or “RS resource set”.
As used herein, the term “sounding reference signal (SRS) transmission” refers to a transmission of SRS resource identified by SRS signal resource indicator (SRI) in a DCI message for uplink grant. Accordingly, term “the latest SRS transmission” refers to the latest transmission of SRS resource identified by SRI in a DCI message for uplink grant.
As used herein, the term “network”/“network device(s)” refer to one or more network devices. Accordingly, terms “network”, “network device(s)” and “one or more network devices” can be used interchangeably.
“Panel with lower capability” can be used interchangeably with “panel with higher capability”, “panel corresponds to lower/higher capability value set index”, “panel used most recently”, “old panel used in initial access/least PRACH”, “panel used in initial access/least PRACH” and so on. In other words, it can be any pre-defined rule known at both network (NW) and UE side, or signaled by NW/UE to each other by configuration/capability reporting/request.
“band-width part (BWP) ID/index” can be used interchangeably with “BWP/component carrier (CC) ID/index”, “CC identity/index”, “cell identity/index””, “physical cell identity/index” and “serving cell identity/index”.
In the context of the present disclosure, the term “above” may refer to “larger than or equal to” or “higher than or equal to”. The term “below” may refer to “smaller than or equal to” or “lower than or equal to”.

As mentioned above, solutions of UL transmission for STxMP or 8Tx UE are still incomplete. Embodiments of the present disclosure provide solutions of communication for UL transmission.

In one solution, a terminal device determines, based on information of one or multiple UL transmissions associated with multiple SRS resource sets, at least one SRS resource set from the multiple SRS resource sets. Then the terminal device transmits the UCI to the network device on one or multiple UL transmissions in association with the at least one SRS resource set. In this way, UCI may be transmitted or multiplexed on the UL transmission with the most reliable resource, and a probability of successful UCI transmission may be improved.

In another solution, a terminal device receives, from a network device, a configuration indicating channel quality parameters (e.g., MCS indexes) of codewords of an UL transmission. The terminal device determines, based on the channel quality parameters, a codeword (for convenience, also referred to as a first codeword herein) from the codewords. Based on the first codeword, the terminal device transmits UCI or a PTRS to the network device. In this way, UCI may be multiplexed on a codeword having the better channel quality, and a probability of successful UCI transmission may be improved. A PTRS may be transmitted in association with a codeword having the better channel quality, and performance of PTRS for phase estimation may be improved.

Principles and implementations of the present disclosure will be described in detail below with reference to the figures.

### Example of Communication Environment

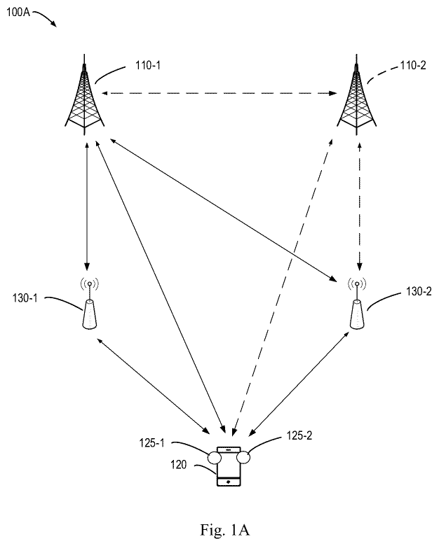

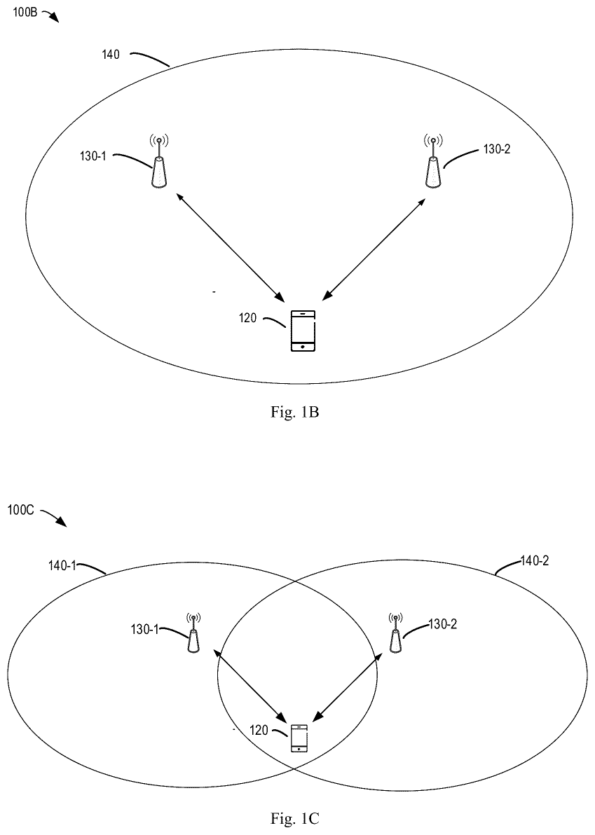

FIG. 1A illustrates an example communication network 100A in which embodiments of the present disclosure can be implemented. The communication network 100A includes a network device 110-1 and an optionally network device 110-2 (collectively or individually referred to as network devices 110). The network device 110 can provide services to a terminal device 120. For purpose of discussion, the network device 110-1 is referred to as the first network device 110-1, and the network device 110-2 is referred to as the second network device 110-2. Further, the first network device 110-1 and the second network device 110-2 can communicate with each other.

In the communication network 100A, a link from the network devices 110 (such as, a first network device 110-1 or the second network device 110-2) to the terminal device 120 is referred to as a downlink, while a link from the terminal device 120 to the network devices 110 (such as, a first network device 110-1 or the second network device 110-2) is referred to as an uplink. In downlink, the first network device 110-1 or the second network device 110-2 is a Tx device (or a transmitter) and the terminal device 120 is a receiving (Rx) device (or a receiver). In uplink, the terminal device 120 is a transmitting Tx device (or a transmitter) and the first network device 110-1 or the second network device 110-2 is a Rx device (or a receiver).

In some embodiments, the network device(s) 110 and the terminal device 120 may communicate with direct links/channels.

In some embodiments, the terminal device 120 may be deployed with more than one panel. As illustrated in FIG. 1A, the terminal device 120 is deployed with panels 125-1 and 125-2. In the following, the panels 125-1 and 125-2 may be referred to as the first panel 125-1 and the second panel 125-2, respectively.

In some embodiments, the first panel 125-1 and the second panel 125-2 correspond to different sets of antenna port(s)/antenna element(s)/antenna array(s). As one specific example, the first panel 125-1 corresponds to a first set of antenna ports and the second panel 125-2 corresponds to a second set of antenna ports. In some embodiments, the panels 125-1 and 125-2 may correspond to different capability value sets, respectively. In some embodiments, the panels 125-1 and 125-2 may correspond to different SRS resource sets, respectively.

In the communication network 100A, a PUSCH STxMP may be supported. Specifically, the terminal device 120 may perform a PUSCH over both of the panels 125-1 and 125-2 simultaneously.

In some embodiments, a MTRP transmission may also be supported. As illustrated in FIG. 1A, the terminal device 120 may communicate with two TRPs, i.e., the TRPs 130-1 and 130-2 (collectively or individually referred to as TRP 130). For purpose of discussion, the TRP 130-1 is referred to as the first TRP 130-1, and the TRP 130-2 is referred to as the second TRP 130-2.

In addition, in order to support MTRP and/or multi-panel, the network device 110 may be equipped with one or more TRPs. For example, the network device 110 may be coupled with multiple TRPs in different geographical locations to achieve better coverage. In one specific example embodiment, the first network device 110-1 is equipped with the first TRP 130-1 and the second TRP 130-2. Alternatively, in another specific example embodiment, the first network device 110-1 and the second network device 110-2 are equipped with the first TRP 130-1 and the second 130-2, respectively.

In some embodiments, the first TRP 130-1 and the second TRP 130-2 are associated with different control resource set pools (CORESET pools). For example, the first TRP 130-1 is associated with a first control resource set pool while the second TRP 130-2 is associated with a second control resource set pool.

Further, both a single TRP mode transmission and MTRP transmission may be supported by the specific example of FIG. 1A. Specifically, in case of the single TRP mode, the terminal device 120 communicates with the network via the first TRP 130-1/second TRP 130-2. Alternatively, in case of the MTRP mode, the terminal device 120 communicates with the network via both of the first TRP 130-1 and the second TRP 130-2.

As one specific example embodiment, during a PUSCH STxMP, the terminal device 120 communicates with the first TRP 130-1 via the panel 125-1 and communicates with the second TRP 130-2 via the panel 125-2 simultaneously.

Further, the network device(s) 110 may provide one or more serving cells and the first TRP 130-1 and the second TRP 130-2 may be included in a same serving cell or different serving cells. In other words, both an inter-cell transmission and an intra-cell transmission are supported by the specific example of FIG. 1A.

FIG. 1B shows an example scenario of the communication network 100A as shown in FIG. 1A. In the specific example of FIG. 1B, the first TRP 130-1 and the second TRP 130-2 are included in a same serving cell 140. In this event, the MTRP transmission is performed as an intra-cell transmission.

FIG. 1C shows another example scenario of the communication network 100A as shown in FIG. 1A. In the specific example of FIG. 1C, the first TRP 130-1 and the second TRP 130-2 are included in different serving cells 140-1 and 140-2. In this event, the MTRP transmission is performed as an inter-cell transmission.

The communications in the communication network 100A may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the numbers of elements (i.e., the terminal device 120, the panel 125, the network device 110, the TRP 130 and the cell 140) and their connection relationships and types shown in FIGS. 1A to 1C are only for purpose of illustration without suggesting any limitation. The communication network 100A may include any suitable numbers of elements adapted for implementing embodiments of the present disclosure.

In some scenarios, the network device 110 may transmit single DCI scheduling an UL transmission via the panels 125-1 and 125-2 in a time division multiplexing (TDM) manner. In some embodiments, the terminal device 120 may perform the UL transmission via the panel 125-1. In some embodiments, the terminal device 120 may perform the UL transmission via the panel 125-2. In some embodiments, the terminal device 120 may perform the UL transmission via the panel 125-1 in an earlier occasion and via the panel 125-2 in a later occasion. In some embodiments, the terminal device 120 may perform the UL transmission via the panel 125-2 in an earlier occasion and via the panel 125-1 in a later occasion. This procedure is a single-DCI based UL transmission in a TDM repetition scheme.

In some scenarios, the network device 110 may transmit single DCI scheduling an UL transmission simultaneously via the panels 125-1 and 125-2 (i.e., the UL transmission is associated with multiple SRS resource sets). This procedure is a single-DCI based STxMP. In some embodiments, different layers or DMRS ports of one UL transmission may be separately precoded and transmitted from different panels simultaneously. This transmission scheme (or transmission mode or mode) may be called as a spatial division multiplexing (SDM) STxMP scheme herein. In some embodiments, all of the same layers or DMRS ports of one PUSCH are transmitted from different panels simultaneously. This transmission scheme (or transmission mode or mode) may be called as a single frequency network (SFN) STxMP scheme herein. It is to be understood that any other suitable operation modes existing or to be developed in future may also be feasible for the single-DCI based STxMP. For example, an FDM scheme may also be feasible. The FDM scheme may comprise an FDM-A scheme where different parts of a frequency domain resource of one PUSCH transmission occasion are transmitted from different UE panels and an FDM-B scheme where two PUSCH transmission occasions with same or different redundancy versions (RV) of the same TB are transmitted from different UE panels on non-overlapped frequency domain resources and the same time domain resources. In another example, an SDM repetition scheme may also be feasible. In the SDM repetition scheme, two PUSCH transmission occasions with different RVs of the same TB are transmitted from two different UE panels simultaneously.

In some scenarios, the network device 110 may transmit multiple DCI (e.g., two DCI) to schedule an UL transmission via the panel 125-1 and an UL transmission via the panel 125-2 respectively that are simultaneously performed. This procedure is a multiple-DCI based STxMP. For the multiple-DCI based STxMP, UL transmissions are associated with different TRPs and transmitted from different panels. It is to be understood that any other suitable operation modes existing or to be developed in future may also be feasible for the multiple-DCI based STxMP.

In the context of the present disclosure, the term “single DCI” may refer to only one value of coresetPoolIndex in ControlResourceSet. The term “multiple DCI” may refer to that UE is configured by a higher layer parameter PDCCH-Config that contains two different values of coresetPoolIndex in ControlResourceSet for the active BWP of a serving cell.

In some scenarios, the terminal device 120 may transmit an aperiodic (AP) or semi-persistent (SP) CSI report to the network device 110. In some embodiments, the CSI or the CSI report in this disclosure may include at least one of channel quality indicator (CQI), precoding matrix indicator (PMI), CSI-RS resource indicator (CRI), synchronization signal/physical broadcast channel (SS/PBCH) block resource indicator (SSBRI), layer indicator (LI), rank indicator (RI), layer 1-reference signal receiving power (L1-RSRP), layer 1-signal to interference plus noise ratio (L1-SINR) or capability index.

In a conventional scheme, a radio resource control (RRC) information element (IE) “CSI-MultiplexingMode” is used to indicate if a behavior of transmitting an AP/SP CSI report on the PUSCH repetitions corresponding to two SRS resource sets is enabled or not. That is, if the behavior is enabled, a terminal device may transmit the AP/SP CSI report to two TRPs. If the behavior is not enabled, a terminal device may transmit the AP/SP CSI report to only one TRP. This is applied for a single-DCI based UL transmission in a TDM repetition scheme, when an SRS resource set indicator field in DCI triggering a CSI report indicates codepoint “10” or “11”. In fact, the RRC IE “CSI-MultiplexingMode” indicates whether a terminal device transmits the AP/SP CSI report to one or two TRPs by indicating whether to transmit or multiplex CSI on only a starting transmission occasion (or actual repetition) or on two transmission occasions.

However, if STxMP is enabled, each transmission occasion or actual repetition is associated with multiple SRS resource sets. Thus, the above conventional scheme is not suitable for STxMP. In other words, it is still unclear how to transmit or multiplex CSI for STxMP.

In addition, to support UCI multiplexing on PUSCH for transmission with rank larger than 4 by 8Tx UE, UCI is always multiplexed only on one of codewords that may be the starting codeword or with the highest MCS index. Meanwhile, for a full-coherent PUSCH transmission with rank 5-8 with one port PTRS, it has been also proposed to study whether an association between PTRS and DMRS is selected based on a codeword with the highest MCS index in case of two codewords.

However, if the highest MCS index is in a special range (e.g., 27, 28, 29, 30 or 31) depending on different MCS tables applied, its corresponding MCS may be used for retransmission and may not reflect channel quality of a corresponding codeword. Similarly, the starting codeword may also be a codeword for retransmission, and may also not reflect its channel quality. In some embodiments, the highest MCS index is smaller than a highest MCS index in a MCS table. In some embodiments, the MCS table is predefined, for example, is predefined for the PUSCH or the UL transmission.

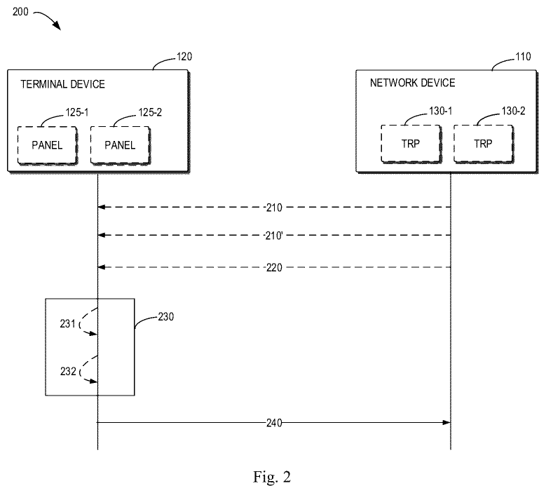

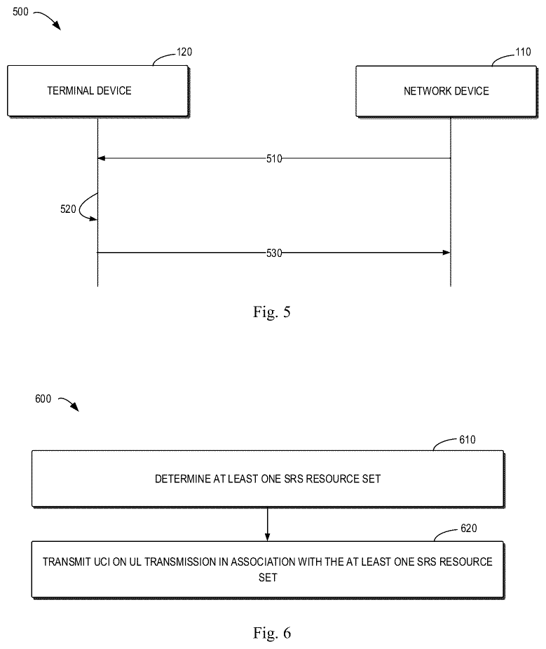

In view of this, embodiments of the present disclosure provide solutions of communication for UL transmission so as to overcome the above or other potential issues. The solution will be described below with reference to FIGS. 2 to 5. FIGS. 2 and 5 illustrate schematic diagrams illustrating processes of communication according to some example embodiments of the present disclosure. For the purpose of discussion, the processes will be described with reference to FIGS. 1A to 1C.

Each of the processes may involve the terminal device 120, the network device 110 (either or both of the first network device 110-1 and the second network device 110-2), and optionally may involve the TRPs 130 (including the first TRP 130-1 and the second TRP 130-2). In other words, the implementations of some embodiments do not depend on the TRPs 130. The terminal device 120 may be deployed with the first panel 125-1 and the second panel 125-2. Further, the first panel 125-1 corresponds to a first set of antenna ports and the second panel 125-2 corresponds to a second set of antenna ports.

Additionally, the first TRP 130-1 is connected to the first network device 110-1, while the second TRP 130-2 is connected to the first network device 110-1/second network device 110-2. In addition, the first TRP 130-1 and the second TRP may be in a same serving cell or in different serving cells.

In the following text, although some embodiments of the present disclosure are described with reference to two TRPs and two panels, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

Further, it is to be understood that the operations at the terminal device 120 and the network device 110 should be coordinated. In other words, the network device 110 and the terminal device 120 should have common understanding about configuration, parameter and so on. Such common understanding may be implemented by any suitable interactions between the network device 110 and the terminal device 120 or both the network device 110 and the terminal device 120 applying the same rule/policy. In the following, although some operations are described from a perspective of the terminal device 120, it is to be understood that the corresponding operations should be performed by the network device 110. Similarly, although some operations are described from a perspective of the network device 110, it is to be understood that the corresponding operations should be performed by the terminal device 120. Merely for brevity, some of the same or similar contents are omitted here.

In addition, in the following description, some interactions are performed among the terminal device 120 and the network device 110 (such as, exchanging capability-related information, configuring/scheduling/activating resource/transmission and so on). It is to be understood that the interactions may be implemented either in one single signaling/message or multiple signaling/messages, including system information, an RRC message, DCI, UCI, a medium access control (MAC) control element (CE) and so on. The present disclosure is not limited in this regard.

In some embodiments, the one or more interaction may be specific to a particular panel, a TRP, a capability value, a CORESET and so on. In this way, PUSCH STxMP may be configured or activated flexibly.

Moreover, it should be understood that although feature(s)/operation(s) are discussed in specific example embodiments separately, unless clearly indicated to the contrary, these feature(s)/operation(s) described in different example embodiments may be used in any suitable combination.

### Example Implementation of UCI Transmission for STxMP

Embodiments of the present disclosure provide a solution of an UCI transmission for STxMP so as to transmit or multiplex UCI on an UL transmission for STxMP. The solution will be described in connection with FIGS. 2 to 4F below.

FIG. 2 illustrates a schematic diagram illustrating a process 200 of communication according to some example embodiments of the present disclosure. For the purpose of discussion, the process 200 will be described with reference to FIGS. 1A to 1C. In this example, the terminal device 120 is deployed with multiple panels (e.g., the panels 125-1 and 125-2). The multiple panels are associated with multiple SRS resource sets.

With reference to FIG. 2, the network device 110 may transmit 210, to the terminal device 120, a configuration about a transmission of UCI. In some embodiments, the configuration may comprise information of one or multiple UL transmissions associated with the multiple SRS resource sets.

In some embodiments, the information of one or multiple UL transmissions may comprise a DCI mode of the one or multiple UL transmissions. For example, in a single-DCI mode, one UL transmission associated with the multiple SRS resource sets is scheduled by single DCI. In a multiple-DCI mode, multiple UL transmissions associated with the multiple SRS resource sets are scheduled by multiple DCI.

In some embodiments, the information of one or multiple UL transmissions may comprise a transmission scheme of the one or multiple UL transmissions. For example, the transmission scheme may comprise at least one of the TDM repetition scheme, the SDM scheme or the SFN scheme. It is to be understood that any other suitable information of one or multiple UL transmissions may also be feasible.

In some embodiments, the configuration may comprise information of the multiple SRS resource sets. For example, two SRS resource sets for codebook (CB) or non-codebook (NCB) may be configured to support STxMP. The two SRS resource sets may be configured in at least one of srs-ResourceSetToAddModList or srs-ResourceSetToAddModListDCI-0-2. If the two SRS resource sets are configured in both srs-ResourceSetToAddModList and srs-ResourceSetToAddModListDCI-0-2, SRS resource set(s) configured in srs-ResourceSetToAddModList may be considered as the two SRS resource sets. An SRS resource set for UCI transmission may be an SRS resource set with a lower resource set ID, if not specifically mentioned.

In some embodiments, the configuration may comprise information of UCI transmission. In some embodiments, the UCI may at least carry an AP or SP CSI report. In this case, the information of UCI transmission may comprise a CSI report configuration and a CSI-RS resource configuration. For example, the CSI report configuration may indicate whether the CSI report is an AP report or an SP report. The CSI-RS resource configuration may provide resources for CSI-RS measurements. The terminal device 120 may perform the CSI-RS measurements on the resources.

In some embodiments, the UCI may comprise hybrid automatic repeated request-acknowledgement (HARQ-ACK) information. In some embodiments, the UCI may comprise a scheduling request (SR). In some embodiments, the UCI may comprise a link recovery request (LRR). It is to be understood that any other suitable UCI may also be feasible.

Continue to refer to FIG. 2, the network device 110 may also transmit 210′, to the terminal device 120, a configuration indicating a repetition associated with the multiple SRS resource sets on multiple occasions. In some embodiments, the configuration indicating the repetition may comprise a repetition type. In some embodiments, the repetition type may be PUSCH repetition Type A in which each slot contains only one repetition and a time domain for repetitions of a TB is the same in those slots. In some embodiments, the repetition type may be PUSCH repetition Type B in which repetitions are carried out in consecutive mini-slots so one slot might contain more than one repetition of a TB. In PUSCH repetition Type B, nominal repetition and actual repetition are introduced to handle cross-slot-boundary case. Both nominal repetition and actual repetition can be considered. Unless otherwise mentioned, for PUSCH repetition Type B, actual repetition is used as an example. It is to be understood that any other suitable repetition types may also be feasible.

In some embodiments, the configuration indicating the repetition may comprise the number of repetitions. Alternatively, the number of repetitions may not be configured. In some embodiments, the number of repetitions may always be 2 regardless of a value of IE numberOfRepetitions or a value of IE pusch-AggregationFactor if IE numberOfRepetitions is not present in a time domain resource allocation table. In some alternatively embodiments, the number of repetitions may always be 1, i.e., not supporting PUSCH repetition together with STxMP.

With reference to FIG. 2, the network device 110 may transmit 220, to the terminal device 120, DCI activating or triggering the UCI transmission (e.g., AP or SP CSI report). In some embodiments, the DCI may comprise an SRS resource set indicator field. For example, the SRS resource set indicator field may indicate codepoint “10” or “11”. In other words, an UL transmission associated with the multiple SRS resource sets may be indicated.

Upon reception of the DCI, the terminal device 120 determines 230 at least one SRS resource set from the multiple SRS resource sets based on the information of one or multiple UL transmissions (e.g., PUSCH transmission) associated with the multiple SRS resource sets. In other words, the terminal device 120 may select at least one panel from the multiple panels for UCI transmission.

With reference to FIG. 2, the terminal device 120 may determine 231 the at least one SRS resource set by default (e.g., based on a DCI mode and/or a transmission scheme of the one or multiple UL transmissions). In some embodiments, if an UL transmission associated with the multiple SRS resource sets is scheduled by single DCI, the terminal device 120 may determine, based on information (e.g., a transmission scheme and so on) of the UL transmission, the at least one SRS resource set for the UCI transmission.

In some embodiments, if the UL transmission is in a first mode, the terminal device 120 may determine the multiple SRS resource sets for the UCI transmission. In some embodiments, the first mode may be based on a SFN (i.e., SFN STxMP scheme) during which a same transmission on a same port associated with the uplink transmission are transmitted simultaneously in association with the multiple SRS resource sets. It is to be understood that the first mode may be based on other suitable transmission schemes.

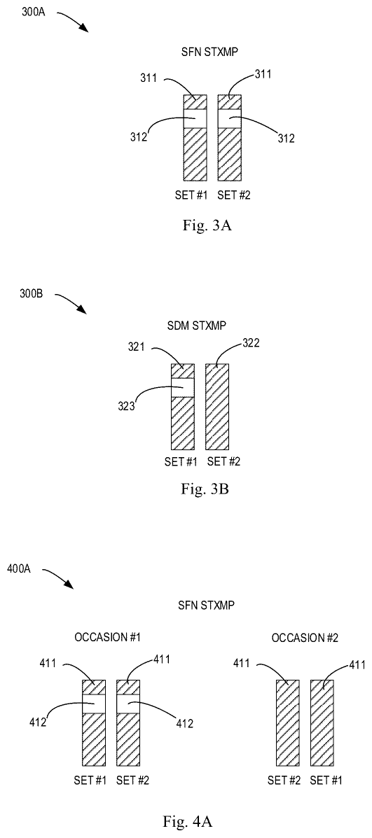

FIG. 3A illustrates a schematic diagram 300A illustrating an example UCI transmission based on a transmission scheme according to some embodiments of the present disclosure. It is assumed that an UL transmission is associated with two SRS resource sets #1 and #2, and the transmission scheme is SFN STxMP. As shown in FIG. 3A, one or more layers 311 of the UL transmission are transmitted in association with the SRS resource set #1, and the same one or more layers 311 of the UL transmission are repeated in association with the SRS resource set #2. In this case, UCI 312 may be transmitted or multiplexed on the UL transmission associated with both the SRS resource sets #1 and #2.

In some embodiments, if the uplink transmission is in a second mode, the terminal device 120 may determine one of the multiple SRS resource sets for the UCI transmission. In some embodiments, the second mode may be based on a SDM (i.e., SDM scheme) during which transmissions on ports associated with the uplink transmission are separately precoded and simultaneously transmitted in association with the multiple SRS resource sets. It is to be understood that the second mode may be based on other suitable transmission schemes.

In some embodiments, the terminal device 120 may determine the one of the multiple SRS resource sets by determining, from the multiple SRS resource sets, an SRS resource set with a lowest SRS resource set index. In some embodiments, the terminal device 120 may determine the one of the multiple SRS resource sets by determining, from the multiple SRS resource sets, an SRS resource set associated with highest transmission power. In some embodiments, the terminal device 120 may determine the one of the multiple SRS resource sets by determining, from the multiple SRS resource sets, an SRS resource set with a predetermined number of starting layers. For example, if the predetermined number is 1, the terminal device 120 may determine, from the multiple SRS resource sets, an SRS resource set with a starting layer (i.e., the first layer).

In some embodiments, the terminal device 120 may determine the one of the multiple SRS resource sets by determining, from the multiple SRS resource sets, an SRS resource set with a smallest number of layers. For example, for a first SRS resource set with 1 layer and a second SRS resource set with 2 layers, the terminal device 120 may determine the first SRS resource set for the UCI transmission.

In some embodiments, the terminal device 120 may determine the one of the multiple SRS resource sets by determining, from the multiple SRS resource sets, an SRS resource set with a largest number of layers. For example, for a first SRS resource set with 1 layer and a second SRS resource set with 2 layers, the terminal device 120 may determine the second SRS resource set for the UCI transmission.

FIG. 3B illustrates a schematic diagram 300B illustrating another example UCI transmission based on a transmission scheme according to some embodiments of the present disclosure. It is assumed that an UL transmission is associated with two SRS resource sets #1 and #2, and the transmission scheme is SDM STxMP. As shown in FIG. 3B, one or more first layers 321 of the UL transmission are transmitted in association with the SRS resource set #1, and one or more second layers 322 of the UL transmission are transmitted in association with the SRS resource set #2. In this case, UCI 323 may be transmitted or multiplexed on the UL transmission (i.e., only the one or more first layers 321) associated with only one SRS resource set (e.g., the SRS resource set #1).

In some alternative embodiments (not shown), by default, the UCI 323 may also be transmitted or multiplexed on the UL transmission (i.e., the one or more first layers 321 and the one or more second layers 322) associated with the SRS resource sets #1 and #2.

In some embodiments, if multiple UL transmissions associated with the multiple SRS resource sets are scheduled by multiple DCI, the terminal device 120 may determine an SRS resource set from the multiple SRS resource sets for the UCI transmission. The SRS resource set and the DCI are associated with a same control resource set pool index.

Continue to refer to FIG. 2, the terminal device 120 may determine 232 the at least one SRS resource set based on an indication of the at least one SRS resource set (i.e., an indication for an UCI transmission or multiplexing mode) from the network device 110. For example, the indication may be provided via RRC configurations.

In some embodiments for an UL transmission associated with the multiple SRS resource sets scheduled by single DCI, if an indication (for convenience, also referred to as a first indication herein) of the at least one SRS resource set is received or enabled or present (e.g., denoted as CSI-MultiplexingModeSTxMP), the terminal device 120 may determine the multiple SRS resource sets for the UCI transmission. If the first indication is not received or not enabled or not present (i.e., absent), the terminal device 120 may determine a predetermined SRS resource set (e.g., an SRS resource set associated with the panel 125-1) in the multiple SRS resource sets for the UCI transmission. In some embodiments, the first indication may comprise the at least one SRS resource set itself. For example, the first indication may comprise the multiple SRS resource sets or one of the multiple SRS resource sets.

In some embodiments, the first indication may be further associated with the information of the UL transmission. In some embodiments, the first indication may be associated with SDM STxMP (e.g., denoted as CSI-MultiplexingModeSDMSTxMP). In other words, the first indication may only apply to SDM STxMP. In some embodiments, for the UL transmission belonging to SDM STxMP, if the first indication associated with SDM STxMP is received or enabled or present, the terminal device 120 may determine the multiple SRS resource sets for the UCI transmission. If the first indication associated with SDM STxMP is not received or not enabled or not present (i.e., absent), the terminal device 120 may determine a predetermined SRS resource set (e.g., an SRS resource set associated with the panel 125-1) in the multiple SRS resource sets for the UCI transmission. In some embodiments, the first indication associated with SDM STxMP may comprise the at least one SRS resource set itself. For example, the first indication associated with SDM STxMP may comprise the multiple SRS resource sets or one of the multiple SRS resource sets.

In some embodiments, the first indication may be associated with SFN STxMP (e.g., denoted as CSI-MultiplexingModeSFNSTxMP). In other words, the first indication may only apply to SFN STxMP. In some embodiments, for the UL transmission belonging to SFN STxMP, if the first indication associated with SFN STxMP is received or enabled or present, the terminal device 120 may determine the multiple SRS resource sets for the UCI transmission. If the first indication associated with SFN STxMP is not received or not enabled or not present (i.e., absent), the terminal device 120 may determine a predetermined SRS resource set (e.g., an SRS resource set associated with the panel 125-1) in the multiple SRS resource sets for the UCI transmission. In some embodiments, the first indication associated with SFN STxMP may comprise the at least one SRS resource set itself. For example, the first indication associated with SFN STxMP may comprise the multiple SRS resource sets or one of the multiple SRS resource sets.

In some embodiments for multiple UL transmissions associated with the multiple SRS resource sets scheduled by multiple DCI, if an indication (for convenience, also referred to as a second indication herein) of the at least one SRS resource set associated with the scheduling by the multiple DCI is received or enabled or present (e.g., denoted as CSI-MultiplexingModeSTxMPPUSCH-PUSCH), the terminal device 120 may determine the multiple SRS resource sets for the UCI transmission. If the second indication is not received or not enabled or not present (i.e., absent), the terminal device 120 may determine a predetermined SRS resource set (e.g., an SRS resource set associated with the panel 125-1) in the multiple SRS resource sets for the UCI transmission. In some embodiments, the second indication may comprise the at least one SRS resource set itself. For example, the second indication may comprise the multiple SRS resource sets or one of the multiple SRS resource sets.

In some alternative embodiments, if an indication (for example, the first or second indication) is received or enabled or present, the terminal device 120 may determine a predetermined SRS resource set for the UCI transmission. If the indication (for example, the first or second indication) is not received or not enabled or not present (i.e., absent), the terminal device 120 may determine the multiple SRS resource sets for the UCI transmission. In other words, the parameter value “enabled, or present” may denote transmitting only with only one SRS resource set (e.g., a predetermined SRS resource set), and the parameter value “not enabled, or not present, or absent” may denote transmitting with the multiple SRS resource sets.

It is to be understood that exact names of the indication may vary, for example, for AP and SP, and separated configurations may be provided as follows: AP-CSI-MultiplexingModeSTxMP-r18, AP-CSI-MultiplexingModeSDMSTxMP-r18, AP-CSI-MultiplexingModeSDMSTxMP-r18, or, AP-CSI-MultiplexingModeSTxMPPUSCH-PUSCH-r18 may be provided in CSI-AssociatedReportConfigInfo for aperiodic CSI report(s). Alternatively, separated configurations may be provided as follows: SP-CSI-MultiplexingModeSTxMP-r18, SP-CSI-MultiplexingModeSDMSTxMP-r18, SP-CSI-MultiplexingModeSDMSTxMP-r18, or, SP-CSI-MultiplexingModeSTxMPPUSCH-PUSCH-r18 may be provided in CSI-SemiPersistentOnPUSCH-TriggerStateList for semi-persistent CSI report(s) on PUSCH. In addition, the names of the indication may include CSI-MultiplexingModeSTxMP-SDCI and CSI-MultiplexingModeSTxMP-MDCI.

Alternatively or additionally, the terminal device 120 may report, to the network device 110, capability of the terminal device 120 indicating whether the terminal device 120 supports an AP and/or SP CSI report multiplexing on PUSCH associated with one SRS resource set or multiple SRS resource sets, for at least one of the following: S-DCI based STxMP PUSCH, M-DCI based STxMP PUSCH, S-DCI based STxMP SFN PUSCH, or S-DCI based STxMP SDM PUSCH.

Continue to refer to FIG. 2, the terminal device 120 transmits 240, to the network device 110, the UCI on the one or multiple UL transmissions in association with the at least one SRS resource set. In some embodiments, if there is no transport blocks (TBs) in the one or multiple UL transmissions, the UCI is transmitted on or over the one or multiple UL transmissions in association with the at least one SRS resource set. In some embodiments, if there is one or more TBs in the one or multiple UL transmissions, the UCI is multiplexed on or over the one or multiple UL transmissions in association with the at least one SRS resource set.

In some embodiments, if the at least one SRS resource set comprises only one SRS resource set, the terminal device 120 may perform, for each panel, at least one of a rate matching or an adjustment of an MCS for the UCI. In some embodiments for the adjustment of the MCS for the UCI, the terminal device 120 may adjust a modulation method of the UCI with respect to the UL transmission. In some embodiments for the adjustment of the MCS for the UCI, the terminal device 120 may adjust a coding rate of the UCI with respect to the UL transmission. In this way, UCI coverage performance may be improved.

In some embodiments where the repetition associated with the multiple SRS resource sets on multiple occasions is configured, the terminal device 120 may transmit the UCI in association with the at least one SRS resource set on at least one occasion of the multiple occasions.

In some embodiments, the terminal device 120 may transmit the UCI in association with the at least one SRS resource set on a starting occasion (i.e., the first occasion) in the multiple occasions (or on a starting actual repetition). In this case, the UCI is not transmitted or multiplexed on remaining occasions following the starting occasion.

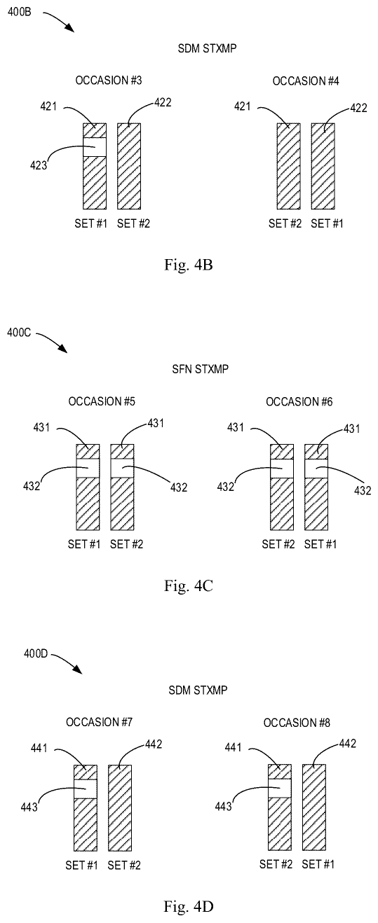

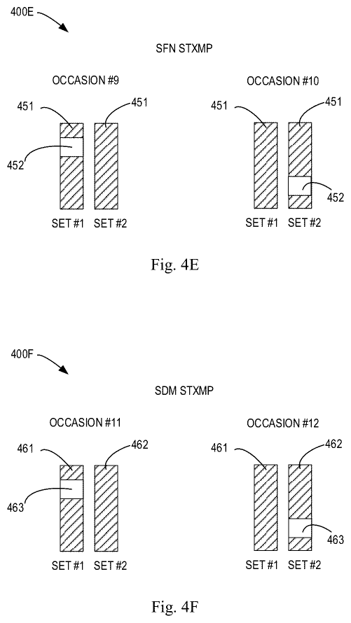

In some embodiments for SFN STxMP, the UCI may be transmitted or multiplexed on the UL transmission with the multiple SRS resource sets for only a starting occasion. FIG. 4A illustrates a schematic diagram 400A illustrating an example UCI transmission based on a transmission scheme and a repetition configuration according to some embodiments of the present disclosure. It is assumed that an UL transmission is associated with two SRS resource sets #1 and #2, and the transmission scheme is SFN STxMP. It is also assumed that the number of repetition is 2 and the UCI is transmitted on only a starting occasion. In addition, it is assumed that the SRS resource set indicator field indicates codepoint “11” for swapping the order of two SRS resource sets in a different transmission occasion. It is to be understood that the same method may also work if the codepoint is “10” for not swapping the order of two SRS resource sets in a different transmission occasion.

As shown in FIG. 4A, on an occasion #1, one or more layers 411 of the UL transmission are transmitted in association with the SRS resource set #1 and the same one or more layers 411 of the UL transmission are transmitted in association with the SRS resource set #2. On an occasion #2 later than the occasion #1, the one or more layers 411 of the UL transmission are transmitted in association with the SRS resource set #2 and the same one or more layers 411 of the UL transmission are transmitted in association with the SRS resource set #1. In this case, UCI 412 may be transmitted or multiplexed on the UL transmission associated with both the SRS resource sets #1 and #2 on a starting occasion (i.e., the occasion #1). There is no UCI transmission on the occasion #2.

In some embodiments for SDM STxMP, the UCI may be transmitted or multiplexed on the UL transmission with only one SRS resource set for only a starting occasion. FIG. 4B illustrates a schematic diagram 400B illustrating another example UCI transmission based on a transmission scheme and a repetition configuration according to some embodiments of the present disclosure. It is assumed that an UL transmission is associated with two SRS resource sets #1 and #2, and the transmission scheme is SDM STxMP. It is also assumed that the number of repetition is 2 and the UCI is transmitted on only a starting occasion. In addition, it is assumed that the SRS resource set indicator field indicates codepoint “11” for swapping the order of two SRS resource sets in a different transmission occasion. It is to be understood that the same method may also work if the codepoint is “10” for not swapping the order of two SRS resource sets in a different transmission occasion.

As shown in FIG. 4B, on an occasion #3, one or more first layers 421 of the UL transmission are transmitted in association with the SRS resource set #1 and one ore more second layers 422 of the UL transmission are transmitted in association with the SRS resource set #2. On an occasion #4 later than the occasion #3, the one or more first layers 421 of the UL transmission are transmitted in association with the SRS resource set #2 and the one or more second layers 422 of the UL transmission are transmitted in association with the SRS resource set #1. In this case, UCI 423 may be transmitted or multiplexed on the UL transmission (i.e., the one or more first layers 421) associated with only the SRS resource sets #1 on a starting occasion (i.e., the occasion #3). There is no UCI transmission on the occasion #4.

In some embodiments, the terminal device 120 may transmit the UCI on a same group of SRS resource sets on the multiple occasions. In other words, the UCI may be transmitted or multiplexed on each occasion (or on each actual repetition).

In some embodiments for SFN STxMP, the UCI may be transmitted or multiplexed on the UL transmission with the multiple SRS resource sets for the multiple occasions. FIG. 4C illustrates a schematic diagram 400C illustrating another example UCI transmission based on a transmission scheme and a repetition configuration according to some embodiments of the present disclosure. It is assumed that an UL transmission is associated with two SRS resource sets #1 and #2, and the transmission scheme is SFN STxMP. It is also assumed that the number of repetition is 2 and the UCI is transmitted on all the occasions. In addition, it is assumed that the SRS resource set indicator field indicates codepoint “11” for swapping the order of two SRS resource sets in a different transmission occasion. It is to be understood that the same method may also work if the codepoint is “10” for not swapping the order of two SRS resource sets in a different transmission occasion.

As shown in FIG. 4C, on an occasion #5, one or more layers 431 of the UL transmission are transmitted in association with the SRS resource set #1 and the same one or more layers 431 of the UL transmission are transmitted in association with the SRS resource set #2. On an occasion #6 later than the occasion #5, the one or more layers 431 of the UL transmission are transmitted in association with the SRS resource set #2 and the same one or more layers 431 of the UL transmission are transmitted in association with the SRS resource set #1. In this case, UCI 432 may be transmitted or multiplexed on the UL transmission associated with both the SRS resource sets #1 and #2 on all the occasions (i.e., the occasions #5 and #6).

In some embodiments for SDM STxMP, the UCI may be transmitted or multiplexed on the UL transmission with only one SRS resource set for the multiple occasions. FIG. 4D illustrates a schematic diagram 400D illustrating another example UCI transmission based on a transmission scheme and a repetition configuration according to some embodiments of the present disclosure. It is assumed that an UL transmission is associated with two SRS resource sets #1 and #2, and the transmission scheme is SDM STxMP. It is also assumed that the number of repetition is 2 and the UCI is transmitted on all the occasions. In addition, it is assumed that the SRS resource set indicator field indicates codepoint “11” for swapping the order of two SRS resource sets in a different transmission occasion. It is to be understood that the same method may also work if the codepoint is “10” for not swapping the order of two SRS resource sets in a different transmission occasion.

As shown in FIG. 4D, on an occasion #7, one or more first layers 441 of the UL transmission are transmitted in association with the SRS resource set #1 and one ore more second layers 442 of the UL transmission are transmitted in association with the SRS resource set #2. On an occasion #8 later than the occasion #7, the one or more first layers 441 of the UL transmission are transmitted in association with the SRS resource set #2 and the one or more second layers 442 of the UL transmission are transmitted in association with the SRS resource set #1. In this case, UCI 443 may be transmitted or multiplexed on the UL transmission (i.e., the one or more first layers 441) associated with only the SRS resource sets #1 on all the occasions (i.e., the occasions #7 and #8).

In some embodiments, the terminal device 120 may transmit the UCI in association with a first SRS resource set of the multiple SRS resource sets on a first occasion of the multiple occasions and in association with a second SRS resource set of the multiple SRS resource sets on a second occasion of the multiple occasions.

In some embodiments for SFN STxMP, the UCI may be transmitted or multiplexed on the UL transmission with a first SRS resource set for a first occasion and a second SRS resource set for a second occasion. FIG. 4E illustrates a schematic diagram 400E illustrating another example UCI transmission based on a transmission scheme and a repetition configuration according to some embodiments of the present disclosure. It is assumed that an UL transmission is associated with two SRS resource sets #1 and #2, and the transmission scheme is SFN STxMP. It is also assumed that the number of repetition is 2 and the UCI is transmitted on all the occasions.

As shown in FIG. 4E, on an occasion #9, one or more layers 451 of the UL transmission are transmitted in association with the SRS resource set #1 and the same one or more layers 451 of the UL transmission are transmitted in association with the SRS resource set #2. On an occasion #10 later than the occasion #9, the one or more layers 451 of the UL transmission are transmitted in association with the SRS resource set #1 and the same one or more layers 451 of the UL transmission are transmitted in association with the SRS resource set #2. In this case, UCI 452 may be transmitted or multiplexed on the one or more layers 451 associated with the SRS resource set #1 on the occasion #9 and on the one or more layers 451 associated with the SRS resource set #2 on the occasion #10.

In some embodiments for SDM STxMP, the UCI may be transmitted or multiplexed on the UL transmission with a first SRS resource set for a first occasion and a second SRS resource set for a second occasion. FIG. 4F illustrates a schematic diagram 400F illustrating another example UCI transmission based on a transmission scheme and a repetition configuration according to some embodiments of the present disclosure. It is assumed that an UL transmission is associated with two SRS resource sets #1 and #2, and the transmission scheme is SDM STxMP. It is also assumed that the number of repetition is 2 and the UCI is transmitted on all the occasions.

As shown in FIG. 4F, on an occasion #11, one or more first layers 461 of the UL transmission are transmitted in association with the SRS resource set #1 and one ore more second layers 462 of the UL transmission are transmitted in association with the SRS resource set #2. On an occasion #12 later than the occasion #11, the one or more first layers 461 of the UL transmission are transmitted in association with the SRS resource set #1 and the one or more second layers 462 of the UL transmission are transmitted in association with the SRS resource set #2 In this case, UCI 463 may be transmitted or multiplexed on the one or more first layers 461 associated with the SRS resource set #1 on the occasion #11 and on the one or more second layers 462 associated with the SRS resource set #2 on the occasion #12.

In some embodiments, the network device 110 may transmit, to the terminal device 120, an indication (for convenience, also referred to as a third indication herein) indicating that the UCI is to be transmitted on an occasion different from a starting occasion of the multiple occasions. In other words, the third indication may be provided to indicate whether and how to multiplex or transmit on occasion(s) (or actual repetition) following the starting occasion.

In some embodiments, if the third indication is received or enabled or present, the terminal device 120 may transmit the UCI in association with the at least one SRS resource set on the multiple occasions. In some embodiments, if the third indication is not received or not enabled or not present (i.e., absent), the terminal device 120 may transmit the UCI on the starting occasion. In some embodiments, the third indication may indicate a detailed configuration for each occasion, e.g., which occasion is to be used for the UCI transmission, which SRS resource set(s) is to be used on the occasion, and so on.

In some embodiments, the indication for the UCI transmission or multiplexing mode (i.e., the first indication or the second indication) may be used in combination with the third indication for the UCI transmission or multiplexing occasion. In some embodiments, if the first or second indication is provided that UCI transmission or multiplexing on UL transmission with multiple SRS resource sets, and the third indication is provided that UCI transmission or multiplexing on each transmission occasion (or each actual repetition), the UCI may be transmitted or multiplexed separately only on each occasion (or actual repetition) in association with the multiple SRS resource sets.

In some embodiments, if the first or second indication is provided that UCI transmission or multiplexing on UL transmission with only one SRS resource set, and the third indication is provided that UCI transmission or multiplexing on each transmission occasion (or each actual repetition), the UCI may be transmitted or multiplexed separately only on each occasion (or actual repetition) in association with the one SRS resource set.

In some embodiments, if the first or second indication is provided that UCI transmission or multiplexing on UL transmission with multiple SRS resource sets, and the third indication is provided that UCI transmission or multiplexing on only one occasion (or one actual repetition), the UCI may be transmitted or multiplexed separately only on the occasion (or actual repetitions) in association with the multiple SRS resource sets.

In some embodiments, if the first or second indication is provided that UCI transmission or multiplexing on UL transmission with only one SRS resource set, and the third indication is provided that UCI transmission or multiplexing on each transmission occasion (or each actual repetition), the UCI may be transmitted or multiplexed separately only on one occasion (or actual repetition) in association with the one SRS resource set.

In some embodiments, the information provided by the first or second indication and/or the third indication may be implicitly determined. For example, the information provided by the first or second indication and/or the third indication may be determined by defining default rules. In another example, the information provided by the first or second indication and/or the third indication may be determined by NW pre-configuration. In another example, the information provided by the first or second indication and/or the third indication may be determined by UE determination.

Alternatively or additionally, the terminal device 120 may report, to the network device 110, capability of the terminal device 120 indicating whether the terminal device 120 supports an AP and/or SP CSI report multiplexing on one occasion (or actual repetition) or multiple occasions (or actual repetitions) associated with the multiple SRS resource sets, for at least one of the following: S-DCI based STxMP PUSCH, M-DCI based STxMP PUSCH, S-DCI based STxMP SFN PUSCH, or S-DCI based STxMP SDM PUSCH.

In some embodiments for CSI report, the term “transmitted” may be used when a DCI format 0_1 and DCI format 0_2 indicate codepoint “10” or “11” for an SRS resource set indicator and schedule aperiodic CSI report(s) or activate semi-persistent CSI report(s) on PUSCH with no TB by a ‘CSI request’ field on DCI. The term “multiplexed” may be used when a DCI format 0_1 and DCI format 0_2 indicate codepoint “10” or “11” for the SRS resource set indicator and schedule aperiodic CSI report(s) on PUSCH with TB by a ‘CSI request’ field on DCI.

If DCI format 0_1 and DCI format 0_2 indicate codepoint “00” or “01” for the SRS resource set indicator, a SRS resource set is directly indicated. Then the UCI may be transmitted or multiplexed on the UL transmission associated with the indicated SRS resource set.

Alternatively, If DCI format 0_1 and DCI format 0_2 indicate codepoint “00” or “01” for the SRS resource set indicator, a SRS resource set is directly indicated. Then the UCI may be transmitted or multiplexed on the UL transmission associated with a SRS resource set different from the indicated SRS resource set.

In addition, if DCI format does not contain the SRS resource set indicator, e.g., DCI format 0_0, the UCI may be transmitted or multiplexed on the UL transmission associated with a SRS resource set with the lowest SRS resource ID. Alternatively, the UCI may be transmitted or multiplexed on the UL transmission associated with two SRS resource sets with the lowest two SRS resource IDs. Alternatively, or in addition, whether the UCI is transmitted or multiplexed on the UL transmission associated with one or two SRS resource set(s) may depend on a configuration, e.g., explicit configuration or depending on a configuration of an STxMP mode.

With the process 200, UCI may be transmitted or multiplexed on the UL transmission with the most reliable resource, and a probability of successful UCI transmission may be improved. It is to be understood that operations described in the process 200 may be carried out in any suitable combination.

### Example Implementation of UL Transmission with Codewords

Embodiments of the present disclosure also provide a solution of an UL transmission with codewords so as to achieve an UCI or PTRS transmission based on a codeword with the better channel quality. It is to be understood that the solution may be applied for STxMP UE or 8Tx UE or any other suitable scenarios supporting two or more codewords. The solution will be described in connection with FIG. 5 below. FIG. 5 illustrates a schematic diagram illustrating another process 500 of communication according to some example embodiments of the present disclosure. For the purpose of discussion, the process 500 will be described with reference to FIGS. 1A to 1C.

With reference to FIG. 5, the network device 110 transmits 510, to the terminal device 120, a configuration indicating MCS indexes of codewords of an UL transmission.

In some embodiments, the UL transmission may have a rank larger than 4. In some embodiments, the UL transmission may correspond to two or more codewords. In some embodiments, the codewords may be transmitted via different TRPs.

It is to be understood that MCS may be replaced by one or more of modulation order, code rate, spectral efficiency, and so on. In other words, although the process 500 is described in connection with MCS of a codeword, the process 500 may also be applied to other channel quality parameters of the codeword.

With reference to FIG. 5, the terminal device 120 determines 520 a codeword (for convenience, also referred to as a first codeword herein) from the codewords, e.g., based on channel quality parameters associated with the codewords. In some embodiments, the first codeword may be associated with channel quality above quality threshold. For example, the first codeword may be associated with the best channel quality among the codewords. In some embodiments, a codeword with a largest MCS index for an initial transmission may be determined as the first codeword. In some embodiments, if codewords at least contains a codeword of an initial transmission and a codeword of a retransmission, the codeword of the initial transmission may be determined as the first codeword, and the codeword of the retransmission cannot be determined as the first codeword.

In some embodiments, if the MCS indexes of the codewords have different values, the terminal device 120 may determine the first codeword from the codewords based on values of the MCS indexes of the codewords and a threshold value. In some embodiments, the threshold value may depend on a MCS table used. For example, the threshold value may be 26, 27, 28 or 29. For example, the threshold value is smaller than a highest MCS index in a MCS table. In some embodiments, the MCS table is predefined, for example, is predefined for the PUSCH or the UL transmission.

In some embodiments, the first codeword may be determined based on a codeword with a highest MCS within a MCS range. In some embodiments, if the values of the MCS indexes are below the threshold value, the terminal device 120 may determine, as the first codeword, a codeword with a highest value of MCS index among the codewords. In some embodiments, if a value of a first MCS index in the MCS indexes is below the threshold value and a value of a second MCS index in the MCS indexes is above the threshold value, the terminal device 120 may determine, as the first codeword, a codeword with the first MCS index among the codewords. In some embodiments, if the values of the MCS indexes are above the threshold value, the terminal device 120 may determine, as the first codeword, a codeword with a highest value of MCS index for an initial transmission of the codeword among the codewords.

In some embodiments, the first codeword may be determined based on a starting codeword within a MCS range. In some embodiments, if the values of the MCS indexes are below the threshold value, the terminal device 120 may determine, as the first codeword, the starting codeword among the codewords. In some embodiments, if the values of the MCS indexes are above the threshold value, the terminal device 120 may determine, as the first codeword, the starting codeword among the codewords.

In some embodiments, if the MCS indexes of the codewords have a same value, the terminal device 120 may determine, as the first codeword, a starting codeword in the codewords.

In some embodiments, the terminal device 120 may report, to the network device 110, capability of the terminal device 120 indicating a method (e.g., any of the above embodiments) of determining the first codeword. In some embodiments, the terminal device 120 may report, to the network device 110, capability of the terminal device 120 indicating that the first codeword is determined based on a codeword with a highest MCS within a MCS range. In some embodiments, the terminal device 120 may report, to the network device 110, capability of the terminal device 120 indicating that the first codeword is determined based on a starting codeword within a MCS range. In some embodiments, the terminal device 120 may report, to the network device 110, capability of the terminal device 120 indicating that the first codeword is determined based on a codeword with a highest MCS within a MCS range or a starting codeword within a MCS range.

In some embodiments, the network device 110 may transmit, to the terminal device 120, an indication of the method of determining the first codeword. In some embodiments, the indication may be transmitted in an RRC configuration or in any other suitable ways. In some embodiments, the indication may indicate the method itself. For example, the indication may indicate that the first codeword is determined based on a codeword with a highest MCS within a MCS range. In another example, the indication may indicate that the first codeword is determined based on a starting codeword within a MCS range.

In some alternative embodiments, if the indication of the method of determining the first codeword is present in the RRC configuration, the first codeword may be determined based on a codeword with a highest MCS within a MCS range. If the indication is absent in the RRC configuration, the first codeword may be determined based on a starting codeword within a MCS range. In some alternative embodiments, if the indication is present in the RRC configuration, the first codeword may be determined based on a starting codeword within a MCS range. If the indication is absent in the RRC configuration, the first codeword may be determined based on a codeword with a highest MCS within a MCS range.

In some embodiments, the terminal device 120 may determine, as the first codeword, a codeword in the codewords that is associated with information of a predetermined SRS resource set configured for the terminal device 120. For example, the terminal device 120 may determine, as the first codeword, a codeword in the codewords that is associated with the predetermined SRS resource set. In another example, the terminal device 120 may determine, as the first codeword, a codeword in the codewords that is associated with a predetermined TRP corresponding to the predetermined SRS resource set. In another example, the terminal device 120 may determine, as the first codeword, a codeword in the codewords that is associated with a predetermined panel corresponding to the predetermined SRS resource set. In another example, the terminal device 120 may determine, as the first codeword, a codeword in the codewords that is associated with a predetermined TCI state corresponding to the predetermined SRS resource set.

In some embodiments, the terminal device 120 may determine, as the first codeword, a codeword in the codewords that is associated with channel quality above a quality threshold. In some embodiments, the terminal device 120 may determine, as the first codeword, a codeword in the codewords that is associated with a modulation order above a modulation order threshold. In some embodiments, the terminal device 120 may determine, as the first codeword, a codeword in the codewords that is associated with a spectral efficiency above a spectral efficiency threshold. In some embodiments, the terminal device 120 may determine, as the first codeword, a codeword in the codewords that is associated with a code rate above a code rate threshold. In some embodiments, the terminal device 120 may determine, as the first codeword, a codeword in the codewords that is associated with a channel quality indicator (CQI) value above a CQI threshold. In some embodiments, the terminal device 120 may determine, as the first codeword, a codeword in the codewords that is associated with a pathloss below a pathloss threshold. In some embodiments, the terminal device 120 may determine, as the first codeword, a codeword in the codewords that is associated with a timing advance (TA) value below a TA threshold.

Continue to refer to FIG. 5, the terminal device 120 transmits 530, based on the first codeword, UCI or a PTRS to the network device 110.

In some embodiments for UCI transmission, the terminal device 120 may multiplex the UCI on the first codeword.

In some embodiments for PTRS transmission, the terminal device 120 may associate the PTRS with the first codeword. Then the terminal device 120 may determine a PTRS port based on DMRS ports associated with the first codeword and an association between PTRS ports and DMRS ports, and transmit the PTRS based on the PTRS port.

For illustration, an example association between PTRS ports and DMRS ports for UL PTRS port 0 may be configured as shown in Table 1 below. In this example, a codeword (CW) with the higher MCS of initial transmission is determined as the first codeword.

TABLE 1

| Value | DMRS port |
|---|---|
| 0 | 1^{st} scheduled DMRS port with the CW with the higher MCS of |
| | initial transmission |
| 1 | 2^{nd} scheduled DMRS port with the CW with the higher MCS of |
| | initial transmission |
| 2 | 3^{rd} scheduled DMRS port with the CW with the higher MCS of |
| | initial transmission |
| 3 | 4^{th} scheduled DMRS port with the CW with the higher MCS of |
| | initial transmission |

With the process 500, UCI may be multiplexed on a codeword having the better channel quality, and a probability of successful UCI transmission may be improved. A PTRS may be transmitted in association with a codeword having the better channel quality, and performance of PTRS for phase estimation may be improved. It is to be understood that operations described in the process 500 may be carried out in any suitable combination. EXAMPLE IMPLEMENTATION OF METHODS

Accordingly, embodiments of the present disclosure provide methods of communication implemented at a terminal device and a network device. These methods will be described below with reference to FIGS. 6 to 9.

FIG. 6 illustrates an example method 600 of communication implemented at a terminal device in accordance with some embodiments of the present disclosure. For example, the method 600 may be performed at the terminal device 120 as shown in FIGS. 1A to 1C. For the purpose of discussion, the method 600 will be described with reference to FIGS. 1A to 1C. It is to be understood that the method 600 may include additional blocks not shown and/or may omit some blocks as shown, and the scope of the present disclosure is not limited in this regard.

At block 610, the terminal device 120 determines at least one SRS resource set from multiple SRS resource sets based on information of an uplink transmission associated with the multiple SRS resource sets. In some embodiments, the information may comprise that the uplink transmission is in at least one of a first mode or a second mode.

In some embodiments, the first mode is based on a SFN during which a same transmission on a same port associated with the uplink transmission are transmitted simultaneously in association with the multiple SRS resource sets. In some embodiments, the second mode is based on a SDM during which transmissions on ports associated with the uplink transmission are separately precoded and simultaneously transmitted in association with the multiple SRS resource sets.

At block 620, the terminal device 120 transmits, to the network device 110, UCI on the uplink transmission in association with the at least one SRS resource set. In some embodiments, the UCI at least carries an AP or SP CSI report. In some embodiments, the terminal device 120 receives, from the network device 110, DCI activating the transmission of the UCI.

In some embodiments, the uplink transmission associated with the multiple SRS resource sets is scheduled by single DCI. In some embodiments, if the uplink transmission is in the first mode, the terminal device 120 may determine the multiple SRS resource sets for the transmission of the UCI. In some embodiments, if the uplink transmission is in the second mode, the terminal device 120 may determine one of the multiple SRS resource sets for the transmission of the UCI.

In some embodiments, the terminal device 120 may determine the one of the multiple SRS resource sets by determining, from the multiple SRS resource sets, an SRS resource set with a lowest SRS resource set index. In some embodiments, the terminal device 120 may determine the one of the multiple SRS resource sets by determining, from the multiple SRS resource sets, an SRS resource set associated with highest transmission power. In some embodiments, the terminal device 120 may determine the one of the multiple SRS resource sets by determining, from the multiple SRS resource sets, an SRS resource set with a predetermined number of starting layers. In some embodiments, the terminal device 120 may determine the one of the multiple SRS resource sets by determining, from the multiple SRS resource sets, an SRS resource set with a smallest number of layers. In some embodiments, the terminal device 120 may determine the one of the multiple SRS resource sets by determining, from the multiple SRS resource sets, an SRS resource set with a largest number of layers.

In some embodiments, if a first indication of the at least one SRS resource set is received from the network device 110, the terminal device 120 may determine the multiple SRS resource sets for the transmission of the UCI. If the first indication is not received from the network device 110, the terminal device 120 may determine a predetermined SRS resource set in the multiple SRS resource sets for the transmission of the UCI. In some embodiments, the first indication may be associated with the information of the uplink transmission.

In some embodiments, if multiple uplink transmissions associated with the multiple SRS resource sets are scheduled by multiple DCI, the terminal device 120 may determine an SRS resource set from the multiple SRS resource sets for the transmission of the UCI. The SRS resource set and the DCI is associated with a same control resource set pool index.

In some embodiments, if the multiple uplink transmissions are scheduled by the multiple DCI and a second indication of the at least one SRS resource set associated with the scheduling by the multiple DCI is received from the network device 110, the terminal device 120 may determine the multiple SRS resource sets for the transmission of the UCI. In some embodiments, if the multiple uplink transmissions are scheduled by the multiple DCI and the second indication is not received from the network device 110, the terminal device 120 may determine a predetermined SRS resource set in the multiple SRS resource sets for the transmission of the UCI.

In some embodiments, the at least one SRS resource set comprises only one SRS resource set and the multiple SRS resource sets are associated with multiple panels of the terminal device. In these embodiments, the terminal device 120 may transmit the UCI by performing, for each of the multiple panels, at least one of a rate matching or an adjustment of an MCS.

In some embodiments, the terminal device 120 may receive, from the network device 110, a configuration indicating a repetition associated with the multiple SRS resource sets on multiple occasions, and transmit the UCI on at least one occasion of the multiple occasions.

In some embodiments, the terminal device 120 may transmit the UCI on a starting occasion in the multiple occasions. In some embodiments, the terminal device 120 may transmit the UCI on a same group of SRS resource sets on the multiple occasions. In some embodiments, the terminal device 120 may transmit the UCI in association with a first SRS resource set of the multiple SRS resource sets on a first occasion of the multiple occasions and in association with a second SRS resource set of the multiple SRS resource sets on a second occasion of the multiple occasions.

In some embodiments, if a third indication indicating that the UCI is to be transmitted on an occasion different from a starting occasion of the multiple occasions is received from the network device 110, the terminal device 120 may transmit the UCI on the multiple occasions. If the third indication is not received from the network device 110, the terminal device 120 may transmit the UCI on the starting occasion.

With the method 600, UCI may be transmitted or multiplexed on the UL transmission with the most reliable resource, and a probability of successful UCI transmission may be improved.

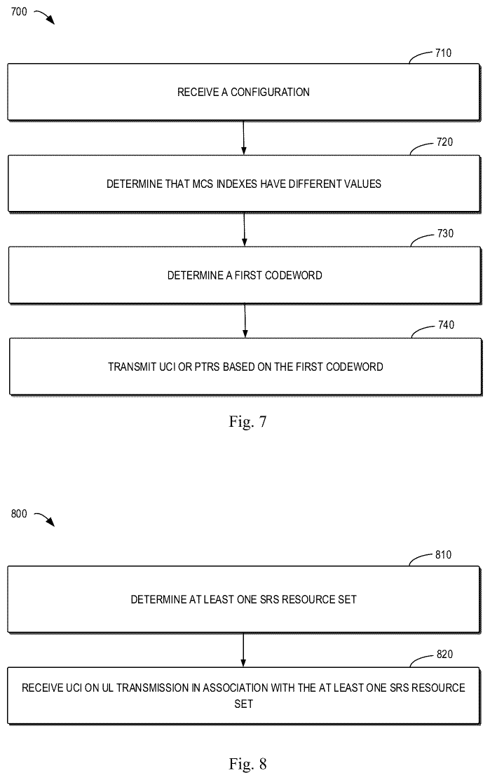

FIG. 7 illustrates another example method 700 of communication implemented at a terminal device in accordance with some embodiments of the present disclosure. For example, the method 700 may be performed at the terminal device 120 as shown in FIGS. 1A to 1C. For the purpose of discussion, the method 700 will be described with reference to FIGS. 1A to 1C. It is to be understood that the method 700 may include additional blocks not shown and/or may omit some blocks as shown, and the scope of the present disclosure is not limited in this regard.

At block 710, the terminal device 120 receives, from the network device 110, a configuration indicating MCS indexes of codewords of an uplink transmission.

At block 720, the terminal device 120 determines that the MCS indexes have different values.

At block 730, the terminal device 120 determines a first codeword from the codewords based on values of the MCS indexes of the codewords and a threshold value.

In some embodiments, if the values of the MCS indexes are below the threshold value, the terminal device 120 may determine, as the first codeword, a codeword with a highest value of MCS index among the codewords. In some embodiments, if a value of a first MCS index in the MCS indexes is below the threshold value and a value of a second MCS index in the MCS indexes is above the threshold value, the terminal device 120 may determine, as the first codeword, a codeword with the first MCS index among the codewords. In some embodiments, if the values of the MCS indexes are above the threshold value, the terminal device 120 may determine, as the first codeword, a codeword with a highest value of MCS index for an initial transmission of the codeword among the codewords.

In some embodiments, if the values of the MCS indexes are below the threshold value, the terminal device 120 may determine, as the first codeword, the starting codeword among the codewords. In some embodiments, if the values of the MCS indexes are above the threshold value, the terminal device 120 may determine, as the first codeword, the starting codeword among the codewords.

In some embodiments where the MCS indexes have a same value, the terminal device 120 may determine, as the first codeword, a starting codeword in the codewords.

At block 740, the terminal device 120 transmits, based on the first codeword, UCI or a PTRS to the network device 110. In some embodiments, the terminal device 120 may multiplex the UCI on the first codeword. In some embodiments, the terminal device 120 may associate the PTRS with the first codeword, and determine a PTRS port based on DMRS ports associated with the first codeword and an association between PTRS ports and DMRS ports. Then the terminal device 120 may transmit the PTRS based on the PTRS port.

With the method 700, UCI may be multiplexed on a codeword having the better channel quality and a probability of successful UCI transmission may be improved. A PTRS may be transmitted in association with a codeword having the better channel quality, and performance of PTRS for phase estimation may be improved.

FIG. 8 illustrates an example method 800 of communication implemented at a network device in accordance with some embodiments of the present disclosure. For example, the method 800 may be performed at the network device 110 (e.g., the network device 110-1 or 110-2) as shown in FIGS. 1A to 1C. For the purpose of discussion, the method 800 will be described with reference to FIGS. 1A to 1C. It is to be understood that the method 800 may include additional blocks not shown and/or may omit some blocks as shown, and the scope of the present disclosure is not limited in this regard.

At block 810, the network device 110 determines at least one SRS resource set from multiple SRS resource sets based on information of an uplink transmission associated with the multiple SRS resource sets. In some embodiments, the information may comprise that the uplink transmission is in at least one of a first mode or a second mode.

At block 820, the network device 110 receives, from the terminal device 120, UCI on the uplink transmission in association with the at least one SRS resource set.

In some embodiments, the UCI at least carries an AP or SP CSI report. In some embodiments, the network device 110 may transmit, to the terminal device 120, DCI activating the transmission of the UCI.

In some embodiments, the uplink transmission associated with the multiple SRS resource sets is scheduled by single DCI. If the uplink transmission is in the first mode, the network device 110 may determine the multiple SRS resource sets for the transmission of the UCI. If the uplink transmission is in the second mode, the network device 110 may determine one of the multiple SRS resource sets for the transmission of the UCI.

In some embodiments, the first mode is based on a SFN during which a same transmission on a same port associated with the uplink transmission are transmitted simultaneously in association with the multiple SRS resource sets. In some embodiments, the second mode is based on a SDM during which transmissions on ports associated with the uplink transmission are separately precoded and simultaneously transmitted in association with the multiple SRS resource sets.

In some embodiments, the network device 110 may determine the one of the multiple SRS resource sets by determining, from the multiple SRS resource sets, an SRS resource set with a lowest SRS resource set index. In some embodiments, the network device 110 may determine the one of the multiple SRS resource sets by determining, from the multiple SRS resource sets, an SRS resource set associated with highest transmission power. In some embodiments, the network device 110 may determine the one of the multiple SRS resource sets by determining, from the multiple SRS resource sets, an SRS resource set with a predetermined number of starting layers. In some embodiments, the network device 110 may determine the one of the multiple SRS resource sets by determining, from the multiple SRS resource sets, an SRS resource set with a smallest number of layers. In some embodiments, the network device 110 may determine the one of the multiple SRS resource sets by determining, from the multiple SRS resource sets, an SRS resource set with a largest number of layers.

In some embodiments, if the multiple SRS resource sets is used for the reception of the UCI, the network device 110 may transmit a first indication of the at least one SRS resource set to the terminal device. If a predetermined SRS resource set in the multiple SRS resource sets is used for the reception of the UCI, the network device 110 may not transmit the first indication to the terminal device. In some embodiments, the first indication may be associated with the information of the uplink transmission.

In some embodiments, if multiple uplink transmissions associated with the multiple SRS resource sets are scheduled by multiple DCI, the network device 110 may determine an SRS resource set from the multiple SRS resource sets for the reception of the UCI. The SRS resource set and the DCI are associated with a same control resource set pool index.

In some embodiments where the multiple uplink transmissions are scheduled by the multiple DCI and the multiple SRS resource sets are used for the reception of the UCI, the network device 110 may transmit, to the terminal device 120, a second indication of the at least one SRS resource set associated with the scheduling by the multiple DCI. In some embodiments, if the multiple uplink transmissions are scheduled by the multiple DCI and a predetermined SRS resource set in the multiple SRS resource sets is used for the reception of the UCI, the network device 110 may not transmit the second indication to the terminal device.

In some embodiments, the network device 110 may transmit, to the terminal device 120, a configuration indicating a repetition of associated with the multiple SRS resource sets on multiple occasions, and receive the UCI on at least one occasion of the multiple occasions.

In some embodiments, the network device 110 may receive the UCI on a starting occasion in the multiple occasions. In some embodiments, the network device 110 may receive the UCI on a same group of SRS resource sets on the multiple occasions. In some embodiments, the network device 110 may receive the UCI in association with a first SRS resource set of the multiple SRS resource sets on a first occasion of the multiple occasions and in association with a second SRS resource set of the multiple SRS resource sets on a second occasion of the multiple occasions.

In some embodiments, if the UCI is to be received on the multiple occasions, the network device 110 may transmit, to the terminal device 120, a third indication indicating that the UCI is to be transmitted on an occasion different from a starting occasion of the multiple occasions. In some embodiments, if the UCI is to be received on the starting occasion, the network device 110 may not transmit the third indication to the terminal device.

With the method 800, a probability of successful UCI transmission may be improved.

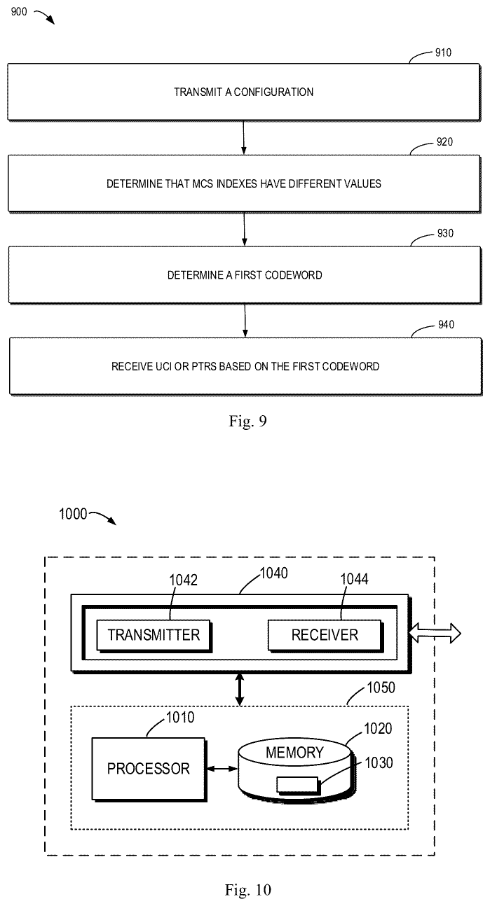

FIG. 9 illustrates another example method 900 of communication implemented at a network device in accordance with some embodiments of the present disclosure. For example, the method 900 may be performed at the network device 110 (e.g., the network device 110-1 or 110-2) as shown in FIGS. 1A to 1C. For the purpose of discussion, the method 900 will be described with reference to FIGS. 1A to 1C. It is to be understood that the method 900 may include additional blocks not shown and/or may omit some blocks as shown, and the scope of the present disclosure is not limited in this regard.

At block 910, the network device 110 transmits, to the terminal device 120, a configuration indicating MCS indexes of codewords of an uplink transmission.

At block 920, the network device 110 determines the MCS indexes have different values.

At block 930, the network device 110 determines a first codeword from the codewords based on values of the MCS indexes of the codewords and a threshold value.

In some embodiments, if the values of the MCS indexes are below the threshold value, the network device 110 may determine, as the first codeword, a codeword with a highest value of MCS index among the codewords. In some embodiments, if a value of a first MCS index in the MCS indexes is below the threshold value and a value of a second MCS index in the MCS indexes is above the threshold value, the network device 110 may determine, as the first codeword, a codeword with the first MCS index among the codewords. In some embodiments, if the values of the MCS indexes are above the threshold value, the network device 110 may determine, as the first codeword, a codeword with a highest value of MCS index for an initial transmission of the codeword among the codewords.

In some embodiments, if the values of the MCS indexes are below the threshold value, the network device 110 may determine, as the first codeword, the starting codeword among the codewords. In some embodiments, if the values of the MCS indexes are above the threshold value, the network device 110 may determine, as the first codeword, the starting codeword among the codewords.

In some embodiments where the MCS indexes have a same value, the network device 110 may determine, as the first codeword, a starting codeword in the codewords.

At block 930, the network device 110 receives, based on the first codeword, UCI or a PTRS from the terminal device 120.

In some embodiments, the network device 110 may receive the UCI multiplexed on the first codeword.

In some embodiments, the network device 110 may associate the PTRS with the first codeword, and determine a PTRS port based on DMRS ports associated with the first codeword and an association between PTRS ports and DMRS ports. Then the network device 110 may receive the PTRS based on the PTRS port.

With the method 900, a probability of successful UCI transmission may be improved, and performance of PTRS for phase estimation may be improved.

FIG. 10 is a simplified block diagram of a device 1000 that is suitable for implementing embodiments of the present disclosure. The device 1000 can be considered as a further example implementation of the terminal device 120 and the network devices 110-1 and 110-2 as shown in FIGS. 1A to 1C. Accordingly, the device 1000 can be implemented at or as at least a part of the terminal 120 and the network devices 110-1 and 110-2.

As shown, the device 1000 includes a processor 1010, a memory 1020 coupled to the processor 1010, a suitable transceiver 1040 coupled to the processor 1010, and a communication interface coupled to the transceiver 1040. The memory 1010 stores at least a part of a program 1030. The transceiver 1040 may be for bidirectional communications or a unidirectional communication based on requirements. The transceiver 1040 may include at least one of a transmitter 1042 or a receiver 1044. The transmitter 1042 and the receiver 1044 may be functional modules or physical entities. The transceiver 1040 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1030 is assumed to include program instructions that, when executed by the associated processor 1010, enable the device 1000 to operate in accordance with the embodiments of the present disclosure, as discussed herein with reference to FIGS. 1A to 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

In some embodiments, a terminal device comprises a circuitry configured to: determine at least one sounding reference signal (SRS) resource set from multiple SRS resource sets based on information of an uplink transmission associated with the multiple SRS resource sets, the information comprising that the uplink transmission is in at least one of a first mode or a second mode; and transmit, to a network device, uplink control information (UCI) on the uplink transmission in association with the at least one SRS resource set.

In some embodiments, a terminal device comprises a circuitry configured to: receive, from a network device, a configuration indicating modulation and coding scheme (MCS) indexes of codewords of an uplink transmission; in accordance with a determination that the MCS indexes have different values, determine a first codeword from the codewords based on values of the MCS indexes of the codewords and a threshold value; and transmit, based on the first codeword, uplink control information (UCI) or a phase tracking reference signal (PTRS) to the network device.

In some embodiments, a network device comprises a circuitry configured to: determine at least one sounding reference signal (SRS) resource set from multiple SRS resource sets based on information of an uplink transmission associated with the multiple SRS resource sets, the information comprising that the uplink transmission is in at least one of a first mode or a second mode; and receive, from a terminal device, uplink control information (UCI) on the uplink transmission in association with the at least one SRS resource set.

In some embodiments, a network device comprises a circuitry configured to: transmit, to a terminal device, a configuration indicating modulation and coding scheme (MCS) indexes of codewords of an uplink transmission; in accordance with a determination that the MCS indexes have different values, determine a first codeword from the codewords based on values of the MCS indexes of the codewords and a threshold value; and receive, based on the first codeword, uplink control information (UCI) or a phase tracking reference signal (PTRS) from the terminal device.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In one solution, a terminal device comprises a processor configured to cause the terminal device to: determine at least one sounding reference signal (SRS) resource set from multiple SRS resource sets based on information of an uplink transmission associated with the multiple SRS resource sets, the information comprising that the uplink transmission is in at least one of a first mode or a second mode; and transmit, to a network device, uplink control information (UCI) on the uplink transmission in association with the at least one SRS resource set.

In some embodiments, the UCI at least carries an aperiodic or semi-persistent report of channel state information (CSI). In some embodiments, the terminal device is further caused to: receive, from the network device, downlink control information (DCI) activating the transmission of the UCI.

In some embodiments, the uplink transmission associated with the multiple SRS resource sets is scheduled by single DCI, and the terminal device is caused to determine the at least one SRS resource set by at least one of the following: in accordance with a determination that the uplink transmission is in the first mode, determining the multiple SRS resource sets for the transmission of the UCI; or in accordance with a determination that the uplink transmission is in the second mode, determining one of the multiple SRS resource sets for the transmission of the UCI.

In some embodiments, the first mode is based on a single frequency network during which a same transmission on a same port associated with the uplink transmission are transmitted simultaneously in association with the multiple SRS resource sets, and the second mode is based on a spatial division multiplexing during which transmissions on ports associated with the uplink transmission are separately precoded and simultaneously transmitted in association with the multiple SRS resource sets.

In some embodiments, the terminal device is caused to determine the one of the multiple SRS resource sets by at least one of the following: determining, from the multiple SRS resource sets, an SRS resource set with a lowest SRS resource set index; determining, from the multiple SRS resource sets, an SRS resource set associated with highest transmission power; determining, from the multiple SRS resource sets, an SRS resource set with a predetermined number of starting layers; determining, from the multiple SRS resource sets, an SRS resource set with a smallest number of layers; or determining, from the multiple SRS resource sets, an SRS resource set with a largest number of layers.

In some embodiments, the terminal device is caused to determine the at least one SRS resource set by at least one of the following: in accordance with a determination that a first indication of the at least one SRS resource set is received from the network device, determining the multiple SRS resource sets for the transmission of the UCI; or in accordance with a determination that the first indication is not received from the network device, determining a predetermined SRS resource set in the multiple SRS resource sets for the transmission of the UCI.

In some embodiments, the first indication is associated with the information of the uplink transmission.

In some embodiments, the terminal device is further caused to at least one of the following: in accordance with a determination that multiple uplink transmissions associated with the multiple SRS resource sets are scheduled by multiple DCI, determine an SRS resource set from the multiple SRS resource sets for the transmission of the UCI, the SRS resource set and the DCI being associated with a same control resource set pool index; in accordance with a determination that the multiple uplink transmissions are scheduled by the multiple DCI and a second indication of the at least one SRS resource set associated with the scheduling by the multiple DCI is received from the network device, determine the multiple SRS resource sets for the transmission of the UCI; or in accordance with a determination that the multiple uplink transmissions are scheduled by the multiple DCI and the second indication is not received from the network device, determine a predetermined SRS resource set in the multiple SRS resource sets for the transmission of the UCI.

In some embodiments, the at least one SRS resource set comprises only one SRS resource set and the multiple SRS resource sets are associated with multiple panels of the terminal device, and the terminal device is caused to transmit the UCI by: performing, for each of the multiple panels, at least one of a rate matching or an adjustment of a modulation and coding scheme (MCS).

In some embodiments, the terminal device is caused to transmit the UCI by: receiving, from the network device, a configuration indicating a repetition associated with the multiple SRS resource sets on multiple occasions; and transmitting the UCI on at least one occasion of the multiple occasions.

In some embodiments, the terminal device is caused to transmit the UCI by: transmitting the UCI on a starting occasion in the multiple occasions; transmitting the UCI on a same group of SRS resource sets on the multiple occasions; or transmitting the UCI in association with a first SRS resource set of the multiple SRS resource sets on a first occasion of the multiple occasions and in association with a second SRS resource set of the multiple SRS resource sets on a second occasion of the multiple occasions.

In some embodiments, the terminal device is caused to transmit the UCI by: in accordance with a determination that a third indication indicating that the UCI is to be transmitted on an occasion different from a starting occasion of the multiple occasions is received from the network device, transmitting the UCI on the multiple occasions; and in accordance with a determination that the third indication is not received from the network device, transmitting the UCI on the starting occasion.

In another solution, a terminal device comprises a processor configured to cause the terminal device to: receive, from a network device, a configuration indicating modulation and coding scheme (MCS) indexes of codewords of an uplink transmission; in accordance with a determination that the MCS indexes have different values, determine a first codeword from the codewords based on values of the MCS indexes of the codewords and a threshold value; and transmit, based on the first codeword, uplink control information (UCI) or a phase tracking reference signal (PTRS) to the network device.

In some embodiments, the terminal device is further caused to: in accordance with a determination that the MCS indexes have a same value, determine, as the first codeword, a starting codeword in the codewords.

In some embodiments, the terminal device is caused to determine the first codeword by at least one of the following: in accordance with a determination that the values of the MCS indexes are below the threshold value, determining, as the first codeword, a codeword with a highest value of MCS index among the codewords; in accordance with a determination that a value of a first MCS index in the MCS indexes is below the threshold value and a value of a second MCS index in the MCS indexes is above the threshold value, determining, as the first codeword, a codeword with the first MCS index among the codewords; in accordance with a determination that the values of the MCS indexes are above the threshold value, determining, as the first codeword, a codeword with a highest value of MCS index for an initial transmission of the codeword among the codewords; in accordance with a determination that the values of the MCS indexes are below the threshold value, determining, as the first codeword, the starting codeword among the codewords; or in accordance with a determination that the values of the MCS indexes are above the threshold value, determining, as the first codeword, the starting codeword among the codewords.

In some embodiments, the terminal device is caused to transmit the UCI by: multiplexing the UCI on the first codeword.

In some embodiments, the terminal device is caused to transmit the PTRS by: associating the PTRS with the first codeword; determining a PTRS port based on demodulation reference signal (DMRS) ports associated with the first codeword and an association between PTRS ports and DMRS ports; and transmitting the PTRS based on the PTRS port.

In another solution, a network device comprises a processor configured to cause the network device to: determine at least one sounding reference signal (SRS) resource set from multiple SRS resource sets based on information of an uplink transmission associated with the multiple SRS resource sets, the information comprising that the uplink transmission is in at least one of a first mode or a second mode; and receive, from a terminal device, uplink control information (UCI) on the uplink transmission in association with the at least one SRS resource set.

In some embodiments, the UCI at least carries an aperiodic or semi-persistent report of channel state information (CSI), and the network device is further caused to: transmit, to the terminal device, downlink control information (DCI) activating the transmission of the UCI.

In some embodiments, the uplink transmission associated with the multiple SRS resource sets is scheduled by single DCI, and the network device is caused to determine the at least one SRS resource set by at least one of the following: in accordance with a determination that the uplink transmission is in the first mode, determining the multiple SRS resource sets for the transmission of the UCI; or in accordance with a determination that the uplink transmission is in the second mode, determining one of the multiple SRS resource sets for the transmission of the UCI.

In some embodiments, the first mode is based on a single frequency network during which a same transmission on a same port associated with the uplink transmission are transmitted simultaneously in association with the multiple SRS resource sets, and the second mode is based on a spatial division multiplexing during which transmissions on ports associated with the uplink transmission are separately precoded and simultaneously transmitted in association with the multiple SRS resource sets.

In some embodiments, the network device is caused to determine the one of the multiple SRS resource sets by at least one of the following: determining, from the multiple SRS resource sets, an SRS resource set with a lowest SRS resource set index; determining, from the multiple SRS resource sets, an SRS resource set associated with highest transmission power; determining, from the multiple SRS resource sets, an SRS resource set with a predetermined number of starting layers; determining, from the multiple SRS resource sets, an SRS resource set with a smallest number of layers; or determining, from the multiple SRS resource sets, an SRS resource set with a largest number of layers.

In some embodiments, the network device is further caused to: in accordance with a determination that the multiple SRS resource sets is used for the reception of the UCI, transmit a first indication of the at least one SRS resource set to the terminal device; and in accordance with a determination that a predetermined SRS resource set in the multiple SRS resource sets is used for the reception of the UCI, transmitting no first indication to the terminal device.

In some embodiments, the first indication is associated with the information of the uplink transmission.

In some embodiments, the network device is further caused to at least one of the following: in accordance with a determination that multiple uplink transmissions associated with the multiple SRS resource sets are scheduled by multiple DCI, determine an SRS resource set from the multiple SRS resource sets for the reception of the UCI, the SRS resource set and the DCI being associated with a same control resource set pool index; in accordance with a determination that the multiple uplink transmissions are scheduled by the multiple DCI and the multiple SRS resource sets are used for the reception of the UCI, transmit, to the terminal device, a second indication of the at least one SRS resource set associated with the scheduling by the multiple DCI; or in accordance with a determination that the multiple uplink transmissions are scheduled by the multiple DCI and a predetermined SRS resource set in the multiple SRS resource sets is used for the reception of the UCI, transmitting no second indication to the terminal device.

In some embodiments, the network device is caused to receive the UCI by: transmitting, to the terminal device, a configuration indicating a repetition of associated with the multiple SRS resource sets on multiple occasions; and receiving the UCI on at least one occasion of the multiple occasions.

In some embodiments, the network device is caused to receive the UCI by: receiving the UCI on a starting occasion in the multiple occasions; receiving the UCI on a same group of SRS resource sets on the multiple occasions; or receiving the UCI in association with a first SRS resource set of the multiple SRS resource sets on a first occasion of the multiple occasions and in association with a second SRS resource set of the multiple SRS resource sets on a second occasion of the multiple occasions.

In some embodiments, the network device is further caused to: in accordance with a determination that the UCI is to be received on the multiple occasions, transmit, to the terminal device, a third indication indicating that the UCI is to be transmitted on an occasion different from a starting occasion of the multiple occasions; and in accordance with a determination that the UCI is to be received on the starting occasion, transmitting no third indication to the terminal device.

In another solution, a network device comprises a processor configured to cause the network device to: transmit, to a terminal device, a configuration indicating modulation and coding scheme (MCS) indexes of codewords of an uplink transmission; in accordance with a determination that the MCS indexes have different values, determine a first codeword from the codewords based on values of the MCS indexes of the codewords and a threshold value; and receive, based on the first codeword, uplink control information (UCI) or a phase tracking reference signal (PTRS) from the terminal device.

In some embodiments, the network device is further caused to: in accordance with a determination that the MCS indexes have a same value, determine, as the first codeword, a starting codeword in the codewords.

In some embodiments, the network device is caused to determine the first codeword by at least one of the following: in accordance with a determination that the values of the MCS indexes are below the threshold value, determining, as the first codeword, a codeword with a highest value of MCS index among the codewords; in accordance with a determination that a value of a first MCS index in the MCS indexes is below the threshold value and a value of a second MCS index in the MCS indexes is above the threshold value, determining, as the first codeword, a codeword with the first MCS index among the codewords; in accordance with a determination that the values of the MCS indexes are above the threshold value, determining, as the first codeword, a codeword with a highest value of MCS index for an initial transmission of the codeword among the codewords; in accordance with a determination that the values of the MCS indexes are below the threshold value, determining, as the first codeword, the starting codeword among the codewords; or in accordance with a determination that the values of the MCS indexes are above the threshold value, determining, as the first codeword, the starting codeword among the codewords.

In some embodiments, the network device is caused to receive the UCI by: receiving the UCI multiplexed on the first codeword.

In some embodiments, the network device is caused to receive the PTRS by: associating the PTRS with the first codeword; determining a PTRS port based on demodulation reference signal (DMRS) ports associated with the first codeword and an association between PTRS ports and DMRS ports; and receiving the PTRS based on the PTRS port.

In another solution, a method of communication comprises: determining, at a terminal device, at least one sounding reference signal (SRS) resource set from multiple SRS resource sets based on information of an uplink transmission associated with the multiple SRS resource sets, the information comprising that the uplink transmission is in at least one of a first mode or a second mode; and transmitting, to a network device, uplink control information (UCI) on the uplink transmission in association with the at least one SRS resource set.

In some embodiments, the UCI at least carries an aperiodic or semi-persistent report of channel state information (CSI). In some embodiments, the method further comprises: receiving, from the network device, downlink control information (DCI) activating the transmission of the UCI.

In some embodiments, the uplink transmission associated with the multiple SRS resource sets is scheduled by single DCI, and determining the at least one SRS resource set comprises at least one of the following: in accordance with a determination that the uplink transmission is in the first mode, determining the multiple SRS resource sets for the transmission of the UCI; or in accordance with a determination that the uplink transmission is in the second mode, determining one of the multiple SRS resource sets for the transmission of the UCI.

In some embodiments, the first mode is based on a single frequency network during which a same transmission on a same port associated with the uplink transmission are transmitted simultaneously in association with the multiple SRS resource sets, and the second mode is based on a spatial division multiplexing during which transmissions on ports associated with the uplink transmission are separately precoded and simultaneously transmitted in association with the multiple SRS resource sets.

In some embodiments, determining the one of the multiple SRS resource sets comprises at least one of the following: determining, from the multiple SRS resource sets, an SRS resource set with a lowest SRS resource set index; determining, from the multiple SRS resource sets, an SRS resource set associated with highest transmission power; determining, from the multiple SRS resource sets, an SRS resource set with a predetermined number of starting layers; determining, from the multiple SRS resource sets, an SRS resource set with a smallest number of layers; or determining, from the multiple SRS resource sets, an SRS resource set with a largest number of layers.

In some embodiments, determining the at least one SRS resource set comprises at least one of the following: in accordance with a determination that a first indication of the at least one SRS resource set is received from the network device, determining the multiple SRS resource sets for the transmission of the UCI; or in accordance with a determination that the first indication is not received from the network device, determining a predetermined SRS resource set in the multiple SRS resource sets for the transmission of the UCI.

In some embodiments, the first indication is associated with the information of the uplink transmission.

In some embodiments, the method further comprises at least one of the following: in accordance with a determination that multiple uplink transmissions associated with the multiple SRS resource sets are scheduled by multiple DCI, determining an SRS resource set from the multiple SRS resource sets for the transmission of the UCI, the SRS resource set and the DCI being associated with a same control resource set pool index; in accordance with a determination that the multiple uplink transmissions are scheduled by the multiple DCI and a second indication of the at least one SRS resource set associated with the scheduling by the multiple DCI is received from the network device, determining the multiple SRS resource sets for the transmission of the UCI; or in accordance with a determination that the multiple uplink transmissions are scheduled by the multiple DCI and the second indication is not received from the network device, determining a predetermined SRS resource set in the multiple SRS resource sets for the transmission of the UCI.

In some embodiments, the at least one SRS resource set comprises only one SRS resource set and the multiple SRS resource sets are associated with multiple panels of the terminal device, and transmitting the UCI comprises: performing, for each of the multiple panels, at least one of a rate matching or an adjustment of a modulation and coding scheme (MCS).

In some embodiments, transmitting the UCI comprises: receiving, from the network device, a configuration indicating a repetition associated with the multiple SRS resource sets on multiple occasions; and transmitting the UCI on at least one occasion of the multiple occasions.

In some embodiments, transmitting the UCI comprises: transmitting the UCI on a starting occasion in the multiple occasions; transmitting the UCI on a same group of SRS resource sets on the multiple occasions; or transmitting the UCI in association with a first SRS resource set of the multiple SRS resource sets on a first occasion of the multiple occasions and in association with a second SRS resource set of the multiple SRS resource sets on a second occasion of the multiple occasions.

In some embodiments, transmitting the UCI comprises: in accordance with a determination that a third indication indicating that the UCI is to be transmitted on an occasion different from a starting occasion of the multiple occasions is received from the network device, transmitting the UCI on the multiple occasions; and in accordance with a determination that the third indication is not received from the network device, transmitting the UCI on the starting occasion.

In another solution, a method of communication comprises: receiving, at a terminal device and from a network device, a configuration indicating modulation and coding scheme (MCS) indexes of codewords of an uplink transmission; in accordance with a determination that the MCS indexes have different values, determining a first codeword from the codewords based on values of the MCS indexes of the codewords and a threshold value; and transmitting, based on the first codeword, uplink control information (UCI) or a phase tracking reference signal (PTRS).

In some embodiments, the method further comprises: in accordance with a determination that the MCS indexes have a same value, determining, as the first codeword, a starting codeword in the codewords.

In some embodiments, determining the first codeword comprises at least one of the following: in accordance with a determination that the values of the MCS indexes are below the threshold value, determining, as the first codeword, a codeword with a highest value of MCS index among the codewords; in accordance with a determination that a value of a first MCS index in the MCS indexes is below the threshold value and a value of a second MCS index in the MCS indexes is above the threshold value, determining, as the first codeword, a codeword with the first MCS index among the codewords; in accordance with a determination that the values of the MCS indexes are above the threshold value, determining, as the first codeword, a codeword with a highest value of MCS index for an initial transmission of the codeword among the codewords; in accordance with a determination that the values of the MCS indexes are below the threshold value, determining, as the first codeword, the starting codeword among the codewords; or in accordance with a determination that the values of the MCS indexes are above the threshold value, determining, as the first codeword, the starting codeword among the codewords.

In some embodiments, transmitting the UCI comprises: multiplexing the UCI on the first codeword.

In some embodiments, transmitting the PTRS comprises: associating the PTRS with the first codeword; determining a PTRS port based on demodulation reference signal (DMRS) ports associated with the first codeword and an association between PTRS ports and DMRS ports; and transmitting the PTRS based on the PTRS port.

In another solution, a method of communication comprises: determining, at a network device, at least one sounding reference signal (SRS) resource set from multiple SRS resource sets based on information of an uplink transmission associated with the multiple SRS resource sets, the information comprising that the uplink transmission is in at least one of a first mode or a second mode; and receiving, from a terminal device, uplink control information (UCI) on the uplink transmission in association with the at least one SRS resource set.

In some embodiments, the UCI at least carries an aperiodic or semi-persistent report of channel state information (CSI), and the method further comprises: transmitting, to the terminal device, downlink control information (DCI) activating the transmission of the UCI.

In some embodiments, the uplink transmission associated with the multiple SRS resource sets is scheduled by single DCI, and determining the at least one SRS resource set comprises at least one of the following: in accordance with a determination that the uplink transmission is in the first mode, determining the multiple SRS resource sets for the transmission of the UCI; or in accordance with a determination that the uplink transmission is in the second mode, determining one of the multiple SRS resource sets for the transmission of the UCI.

In some embodiments, the first mode is based on a single frequency network during which a same transmission on a same port associated with the uplink transmission are transmitted simultaneously in association with the multiple SRS resource sets, and the second mode is based on a spatial division multiplexing during which transmissions on ports associated with the uplink transmission are separately precoded and simultaneously transmitted in association with the multiple SRS resource sets.

In some embodiments, determining the one of the multiple SRS resource sets comprises at least one of the following: determining, from the multiple SRS resource sets, an SRS resource set with a lowest SRS resource set index; determining, from the multiple SRS resource sets, an SRS resource set associated with highest transmission power; determining, from the multiple SRS resource sets, an SRS resource set with a predetermined number of starting layers; determining, from the multiple SRS resource sets, an SRS resource set with a smallest number of layers; or determining, from the multiple SRS resource sets, an SRS resource set with a largest number of layers.

In some embodiments, the method further comprises: in accordance with a determination that the multiple SRS resource sets is used for the reception of the UCI, transmitting a first indication of the at least one SRS resource set to the terminal device; and in accordance with a determination that a predetermined SRS resource set in the multiple SRS resource sets is used for the reception of the UCI, transmitting no first indication to the terminal device.

In some embodiments, the first indication is associated with the information of the uplink transmission.

In some embodiments, the method further comprises at least one of the following: in accordance with a determination that multiple uplink transmissions associated with the multiple SRS resource sets are scheduled by multiple DCI, determining an SRS resource set from the multiple SRS resource sets for the reception of the UCI, the SRS resource set and the DCI being associated with a same control resource set pool index; in accordance with a determination that the multiple uplink transmissions are scheduled by the multiple DCI and the multiple SRS resource sets are used for the reception of the UCI, transmitting, to the terminal device, a second indication of the at least one SRS resource set associated with the scheduling by the multiple DCI; or in accordance with a determination that the multiple uplink transmissions are scheduled by the multiple DCI and a predetermined SRS resource set in the multiple SRS resource sets is used for the reception of the UCI, transmitting no second indication to the terminal device.

In some embodiments, receiving the UCI comprises: transmitting, to the terminal device, a configuration indicating a repetition of associated with the multiple SRS resource sets on multiple occasions; and receiving the UCI on at least one occasion of the multiple occasions.

In some embodiments, receiving the UCI comprises: receiving the UCI on a starting occasion in the multiple occasions; receiving the UCI on a same group of SRS resource sets on the multiple occasions; or receiving the UCI in association with a first SRS resource set of the multiple SRS resource sets on a first occasion of the multiple occasions and in association with a second SRS resource set of the multiple SRS resource sets on a second occasion of the multiple occasions.

In some embodiments, the method further comprises: in accordance with a determination that the UCI is to be received on the multiple occasions, transmitting, to the terminal device, a third indication indicating that the UCI is to be transmitted on an occasion different from a starting occasion of the multiple occasions; and in accordance with a determination that the UCI is to be received on the starting occasion, transmitting no third indication to the terminal device.

In another solution, a method of communication comprises: transmitting, at a network device and to a terminal device, a configuration indicating modulation and coding scheme (MCS) indexes of codewords of an uplink transmission; in accordance with a determination that the MCS indexes have different values, determining a first codeword from the codewords based on values of the MCS indexes of the codewords and a threshold value; and receiving, based on the first codeword, uplink control information (UCI) or a phase tracking reference signal (PTRS) from the terminal device.

In some embodiments, the method further comprises: in accordance with a determination that the MCS indexes have a same value, determining, as the first codeword, a starting codeword in the codewords.

In some embodiments, determining the first codeword comprises at least one of the following: in accordance with a determination that the values of the MCS indexes are below the threshold value, determining, as the first codeword, a codeword with a highest value of MCS index among the codewords; in accordance with a determination that a value of a first MCS index in the MCS indexes is below the threshold value and a value of a second MCS index in the MCS indexes is above the threshold value, determining, as the first codeword, a codeword with the first MCS index among the codewords; in accordance with a determination that the values of the MCS indexes are above the threshold value, determining, as the first codeword, a codeword with a highest value of MCS index for an initial transmission of the codeword among the codewords; in accordance with a determination that the values of the MCS indexes are below the threshold value, determining, as the first codeword, the starting codeword among the codewords; or in accordance with a determination that the values of the MCS indexes are above the threshold value, determining, as the first codeword, the starting codeword among the codewords.

In some embodiments, receiving the UCI comprises: receiving the UCI multiplexed on the first codeword.

In some embodiments, receiving the PTRS comprises: associating the PTRS with the first codeword; determining a PTRS port based on demodulation reference signal (DMRS) ports associated with the first codeword and an association between PTRS ports and DMRS ports; and receiving the PTRS based on the PTRS port.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1A to 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A terminal device, comprising:
a processor configured to cause the terminal device to:
determine at least one sounding reference signal (SRS) resource set from multiple SRS resource sets based on information of an uplink transmission associated with the multiple SRS resource sets, the information comprising that the uplink transmission is in at least one of a first mode or a second mode; and
transmit, to a network device, uplink control information (UCI) on the uplink transmission in association with the at least one SRS resource set.

2. The terminal device of claim 1, wherein the UCI at least carries an aperiodic or semi-persistent report of channel state information (CSI), and wherein the terminal device is further caused to:
receive, from the network device, downlink control information (DCI) activating the transmission of the UCI.

3. The terminal device of claim 1, wherein the uplink transmission associated with the multiple SRS resource sets is scheduled by single DCI, and wherein the terminal device is caused to determine the at least one SRS resource set by at least one of the following:
in accordance with a determination that the uplink transmission is in the first mode, determining the multiple SRS resource sets for the transmission of the UCI; or
in accordance with a determination that the uplink transmission is in the second mode, determining one of the multiple SRS resource sets for the transmission of the UCI.

4. The terminal device of claim 3, wherein the first mode is based on a single frequency network during which a same transmission on a same port associated with the uplink transmission are transmitted simultaneously in association with the multiple SRS resource sets, and
wherein the second mode is based on a spatial division multiplexing during which transmissions on ports associated with the uplink transmission are separately precoded and simultaneously transmitted in association with the multiple SRS resource sets.

5. The terminal device of claim 3, wherein the terminal device is caused to determine the one of the multiple SRS resource sets by at least one of the following:
determining, from the multiple SRS resource sets, an SRS resource set with a lowest SRS resource set index;
determining, from the multiple SRS resource sets, an SRS resource set associated with highest transmission power;
determining, from the multiple SRS resource sets, an SRS resource set with a predetermined number of starting layers;
determining, from the multiple SRS resource sets, an SRS resource set with a smallest number of layers; or
determining, from the multiple SRS resource sets, an SRS resource set with a largest number of layers.

6. The terminal device of claim 1, wherein the terminal device is caused to determine the at least one SRS resource set by at least one of the following:
in accordance with a determination that a first indication of the at least one SRS resource set is received from the network device, determining the multiple SRS resource sets for the transmission of the UCI; or
in accordance with a determination that the first indication is not received from the network device, determining a predetermined SRS resource set in the multiple SRS resource sets for the transmission of the UCI.

7. The terminal device of claim 6, wherein the first indication is associated with the information of the uplink transmission.

8. The terminal device of claim 1, wherein the terminal device is further caused to at least one of the following:
in accordance with a determination that multiple uplink transmissions associated with the multiple SRS resource sets are scheduled by multiple DCI, determine an SRS resource set from the multiple SRS resource sets for the transmission of the UCI, the SRS resource set and the DCI being associated with a same control resource set pool index;
in accordance with a determination that the multiple uplink transmissions are scheduled by the multiple DCI and a second indication of the at least one SRS resource set associated with the scheduling by the multiple DCI is received from the network device, determine the multiple SRS resource sets for the transmission of the UCI; or
in accordance with a determination that the multiple uplink transmissions are scheduled by the multiple DCI and the second indication is not received from the network device, determine a predetermined SRS resource set in the multiple SRS resource sets for the transmission of the UCI.

9. The terminal device of claim 1, wherein the at least one SRS resource set comprises only one SRS resource set and the multiple SRS resource sets are associated with multiple panels of the terminal device, and wherein the terminal device is caused to transmit the UCI by:
performing, for each of the multiple panels, at least one of a rate matching or an adjustment of a modulation and coding scheme (MCS).

10. The terminal device of claim 1 or 8, wherein the terminal device is caused to transmit the UCI by:
receiving, from the network device, a configuration indicating a repetition associated with the multiple SRS resource sets on multiple occasions; and
transmitting the UCI on at least one occasion of the multiple occasions.

11. The terminal device of claim 10, wherein the terminal device is caused to transmit the UCI by:
transmitting the UCI on a starting occasion in the multiple occasions;
transmitting the UCI on a same group of SRS resource sets on the multiple occasions; or
transmitting the UCI in association with a first SRS resource set of the multiple SRS resource sets on a first occasion of the multiple occasions and in association with a second SRS resource set of the multiple SRS resource sets on a second occasion of the multiple occasions.

12. The terminal device of claim 10, wherein the terminal device is caused to transmit the UCI by:
in accordance with a determination that a third indication indicating that the UCI is to be transmitted on an occasion different from a starting occasion of the multiple occasions is received from the network device, transmitting the UCI on the multiple occasions; and
in accordance with a determination that the third indication is not received from the network device, transmitting the UCI on the starting occasion.

13. A terminal device, comprising:
a processor configured to cause the terminal device to:
receive, from a network device, a configuration indicating modulation and coding scheme (MCS) indexes of codewords of an uplink transmission;
in accordance with a determination that the MCS indexes have different values, determine a first codeword from the codewords based on values of the MCS indexes of the codewords and a threshold value; and
transmit, based on the first codeword, uplink control information (UCI) or a phase tracking reference signal (PTRS) to the network device.

14. The terminal device of claim 13, wherein the terminal device is further caused to:
in accordance with a determination that the MCS indexes have a same value, determine, as the first codeword, a starting codeword in the codewords.

15. The terminal device of claim 13, wherein the terminal device is caused to determine the first codeword by at least one of the following:
in accordance with a determination that the values of the MCS indexes are below the threshold value, determining, as the first codeword, a codeword with a highest value of MCS index among the codewords;
in accordance with a determination that a value of a first MCS index in the MCS indexes is below the threshold value and a value of a second MCS index in the MCS indexes is above the threshold value, determining, as the first codeword, a codeword with the first MCS index among the codewords;
in accordance with a determination that the values of the MCS indexes are above the threshold value, determining, as the first codeword, a codeword with a highest value of MCS index for an initial transmission of the codeword among the codewords;
in accordance with a determination that the values of the MCS indexes are below the threshold value, determining, as the first codeword, the starting codeword among the codewords; or
in accordance with a determination that the values of the MCS indexes are above the threshold value, determining, as the first codeword, the starting codeword among the codewords.

16. The terminal device of claim 13, wherein the terminal device is caused to transmit the UCI by:
multiplexing the UCI on the first codeword.

17. The terminal device of claim 13, wherein the terminal device is caused to transmit the PTRS by:
associating the PTRS with the first codeword;
determining a PTRS port based on demodulation reference signal (DMRS) ports associated with the first codeword and an association between PTRS ports and DMRS ports; and
transmitting the PTRS based on the PTRS port.

18. A network device, comprising:
a processor configured to cause the network device to:
determine at least one sounding reference signal (SRS) resource set from multiple SRS resource sets based on information of an uplink transmission associated with the multiple SRS resource sets, the information comprising that the uplink transmission is in at least one of a first mode or a second mode; and
receive, from a terminal device, uplink control information (UCI) on the uplink transmission in association with the at least one SRS resource set.

19. The network device of claim 18, wherein the UCI at least carries an aperiodic or semi-persistent report of channel state information (CSI), and wherein the network device is further caused to:
transmit, to the terminal device, downlink control information (DCI) activating the transmission of the UCI.

20. The network device of claim 18, wherein the uplink transmission associated with the multiple SRS resource sets is scheduled by single DCI, and wherein the network device is caused to determine the at least one SRS resource set by at least one of the following:
in accordance with a determination that the uplink transmission is in the first mode, determining the multiple SRS resource sets for the transmission of the UCI; or
in accordance with a determination that the uplink transmission is in the second mode, determining one of the multiple SRS resource sets for the transmission of the UCI.
